(19) United States
(12) Patent Application Publication
(10) Pub. No.: US 2026/0360634 A1
(43) Pub. Date: Nov. 12, 2026

(54) ENERGY STORAGE MECHANISM FOR STATE-SWITCHING OPERATION OF ELECTRICAL CONTROL SYSTEM

(71) Applicant: Beijing GreenCentury Technology Co., Ltd., Beijing (CN)

(72) Inventors: Gang WANG, Beijing (CN); Xiaochun GU, Beijing (CN); Yulin ZHANG, Beijing (CN); Shunliang XIE, Beijing (CN); Yanbing LIU, Beijing (CN)

(73) Assignee: Beijing GreenCentury Technology Co., Ltd., Beijing (CN)

(21) Appl. No.: 19/477,053

(22) PCT Filed: Jul. 22, 2024
(86) PCT No.: PCT/CN2024/106682

§ 371 Date: Oct. 20, 2025

(30) Foreign Application Priority Data
Jan. 4, 2024 (CN) 202410014244.9

(51) Int. Cl. H01H 3/30

(52) U.S. Cl. CPC H01H 3/3031; H01H 3/3005; H01H 3/3042; H01H 2003/3068

(57) ABSTRACT

The present invention relates to an energy storage mechanism for state switching operation in an electrical control system, comprising: a housing; an operating assembly including an energy storage element; an actuator connected to a state-switching unit of the electrical control system; a locking assembly, wherein the energy storage element connects the operating assembly and the actuator and is enabled to store energy by changing a relative position between the operating assembly and the actuator, and the operating assembly is connectable to the actuator through the locking assembly to be in a locked state; and wherein the operating assembly is then driven to move in an opposite direction, which moves the actuator in the same direction, thereby the actuator drives the state-switching unit of the electrical control system to change its position state; and an unlocking assembly which, upon receiving a trigger signal, is capable of releasing the locked state between the operating assembly and the actuator, and the actuator then moving under the released energy of the energy storage element, thereby driving the state-switching unit of the electrical control system to change its position state again. The present invention enables opening in a free tripping way, so as to realize free tripping.

### TECHNICAL FIELD

The present invention relates to a field of switches, and more particularly to an energy storage mechanism for state switching operation in an electrical control system.

### BACKGROUND ART

With the development of technology, especially in photovoltaic systems, photovoltaic DC switches are applied in inverters to control the working status of multiple core components. The reliability of photovoltaic DC switches is not only related to good operation of the entire photovoltaic system, but also to stable development of the photovoltaic industry.

Problem 1: For current free tripping devices for state-switching units of the electrical control system on the market, when the drive handle (also known as the knob) needs to store energy for the tripping device part meanwhile for the internal energy storage element of the driving mechanism part, this results in a significantly high torsional moment required for the handle. This makes it difficult for ordinary people to hold and maneuver the handle to achieve energy storage, leading to operational inconvenience and heightened difficulty in controlling the state-switching units of the electrical control system. One proposed solution is to increase the size of the handle to increase the length of its force arm, so as to drive the mechanism to close the switch and store energy more effortlessly. However, this type of handle occupies a large space and incurs higher manufacturing costs.

Problem 2: At the same time, the free tripping devices for a state-switching unit of the electrical control system on the market have the characteristics of quick shutdown, but cannot achieve the function of free tripping. For example, when inspecting and maintaining electrical lines and photovoltaic equipment, if the maintenance personnel need to energize the lines and drive the handle to close the state-switching unit of the electrical control system during the inspecting and maintaining process, and at the moment of closing, abnormalities are prone to occur in the inverter. When abnormalities occur, the free tripping device needs to be immediately controlled to perform free tripping action on the state-switching unit of the electrical control system to complete rapid opening. However, due to the manual control of the handle of the state-switching unit of the electrical control system, the tripping unit cannot perform opening operation on the state-switching unit of the electrical control system at the moment of closing, which is likely to cause damage to the equipment and injury to operators. That is, the free tripping process will be restricted by the handle and the free tripping function cannot be completed.

Therefore, there is a need for further improvement in the existing energy storage mechanisms for state switching operation in an electrical control system.

The information disclosed in the background section of the present invention is only intended to increase an understanding of the overall background of the present invention, and should not be regarded as acknowledging or implying in any form that the information constitutes the prior art that is already well-known to those skilled in the art.

### SUMMARY OF THE INVENTION

The objective of the present invention is to provide an energy storage mechanism for state switching operation in an electrical control system, which can unlock a locking assembly through an unlocking assembly, thereby releasing the locked state between an operating assembly and an actuator. The operating assembly is limited by the housing and cannot move in the direction in which a torsional moment is applied thereto by the energy storage element, so that the actuator is no longer limited by the operating assembly and rotates in another direction under driving of the energy storage element, executing the opening action of the state-switching unit of the electrical control system and achieving free tripping.

The present invention provides an energy storage mechanism for state switching operation in an electrical control system, comprising: a housing; an operating assembly mounted to the housing and including an energy storage element; an actuator connected to a state-switching unit of the electrical control system; a locking assembly mounted to the operating assembly or the actuator, wherein the energy storage element connects the operating assembly and the actuator and is enabled to store energy by changing a relative position between the operating assembly and the actuator, and after the relative position between the operating assembly and the actuator is changed to a predetermined position, the operating assembly is connectable to the actuator through the locking assembly to be in a locked state; the operating assembly is then driven to move in an opposite direction, which drives the actuator to move in the same direction, and the operating assembly drives the actuator to reach a restricted position of the operating assembly restricted by the housing, thereby causing the actuator to drive the position state of the state-switching unit of the electrical control system to change; and an unlocking assembly mounted to the housing or the operating assembly or the actuator, wherein the unlocking assembly, upon receiving a trigger signal, is capable of releasing the locked state between the operating assembly and the actuator, allowing the energy storage element to release the stored energy, and the operating assembly is restricted by the housing from moving in a direction in which a force is applied thereto by the energy storage element, and the actuator is movable in a direction in which a force is applied thereto by the energy storage element under driving of energy release from the energy storage element, thereby driving the position state of the state-switching unit of the electrical control system to change again.

Preferably, the operating assembly is rotated in a first direction to change the relative position between the operating assembly and the actuator so that the energy storage element stores energy; after the operating assembly rotates to a predetermined position relative to the actuator, the operating assembly is connectable with the actuator via the locking assembly to be in a locked state; the operating assembly is then rotated in a second direction, which drives the actuator to rotate in the second direction, and the operating assembly drives the actuator to reach a restricted position of the operating assembly restricted by the housing, thereby causing the actuator to drive the position state of the state-switching unit of the electrical control system to change.

Preferably, the operating assembly and the actuator are locked by the locking assembly, so as to be combined as a whole and can move together, and the energy storage element connected between the operating assembly and the actuator stores energy, which can force the relative position between the operating assembly and the actuator to have a tendency to move away, or can force the relative position between the operating assembly and the actuator to have a tendency to move closer.

Preferably, the locking assembly comprises a locking part and a tripping part, and by changing position state of the locking part, connection between the operating assembly and the actuator is achieved to be a locked state, thereby enabling the operating assembly to move in the same direction as the actuator and driving the position state of the state-switching unit of the electrical control system to change; or, by changing position state of the tripping part via the unlocking assembly, the locked state between the operating assembly and the actuator is released, thereby enabling the energy storage element to release energy and drive the actuator to move.

Preferably, the energy storage element is a torsion spring accumulator or a coiled spring accumulator.

Preferably, the locking assembly comprises a locking part and a tripping part; the locking part comprises a locking rod and a locking rod torsion spring that applies a torsional moment to the locking rod and is capable of causing the locking rod to rotate in the second direction or have a tendency to rotate in the second direction; the locking rod is mounted to the operating assembly through a locking rod fixed shaft and is rotatable around the locking rod fixed shaft; the tripping part comprises a tripping rod and a tripping rod torsion spring that applies a torsional moment to the tripping rod and is capable of causing the tripping rod to rotate in the first direction or have a tendency to rotate in the first direction; the tripping rod is mounted to the operating assembly through a tripping rod fixed shaft and is rotatable around the tripping rod fixed shaft.

Preferably, the locking rod comprises: a locking rod upper plate that is horizontally arranged; a locking rod lower plate that is horizontally arranged and has a stop plate, wherein the locking rod upper plate and the locking rod lower plate each have a locking rod limit hole for the locking rod fixed shaft to pass through; and a locking rod connecting plate that is vertically arranged, by which the locking rod upper plate is connected to the locking rod lower plate, wherein an end face of the locking rod connecting plate facing the locking rod limit hole has a locking groove, a side of the locking rod connecting plate away from the locking rod limit hole has a locking rod abutment surface, and the locking rod connecting plate further has a locking rod stop surface facing away from the stop plate; the tripping rod comprises: a tripping rod upper plate that is horizontally arranged; a tripping rod lower plate that is horizontally arranged, and has a tripping rod stop surface and a tripping rod abutment surface, wherein the tripping rod stop surface is used to cooperate with the locking rod stop surface on the locking rod to form a bearing state, so that the operating assembly forms an interlocking structure with the actuator through the locking part; and a vertical tripping rod connecting plate, by which the tripping rod upper plate is connected to the tripping rod lower plate.

Preferably, the tripping rod lower plate further includes a tripping arm.

Preferably, the locking part comprises a locking rod which is mounted to the operating assembly through a locking rod fixed shaft, wherein the locking rod comprises: a locking rod upper plate that is horizontally arranged; a locking rod lower plate that is horizontally arranged and has a stop plate, wherein the locking rod upper plate and the locking rod lower plate each have a locking rod limit hole for the locking rod fixed shaft to pass through; and a locking rod connecting plate that is vertically arranged, by which the locking rod upper plate is connected to the locking rod lower plate, wherein an end face of the locking rod connecting plate facing the locking rod limit hole has a locking groove, wherein the actuator includes a plate-shaped actuator body, which has sequentially at an outer edge thereof extending upward: a push plate that is contactable with the stop plate of the locking rod and can force the locking rod to rotate around the locking rod fixed shaft in the first direction after contact; a locking protrusion that can be locked in cooperating with the locking groove of the locking rod; and a stop plate of the energy storage element.

Preferably, the actuator comprises a plate-shaped actuator body, which has at an outer edge thereof a connection positioning plate that is extending downward and passes downward through the housing to be connected with the state-switching unit of the electrical control system, wherein when the actuator rotates in the second direction, the state-switching unit of the electrical control system performs closing operation, and when the actuator rotates in the first direction, the state-switching unit of the electrical control system performs opening operation.

Preferably, the actuator body further has a deflection torsion spring limit hole.

Preferably, the unlocking assembly comprises: an unlocking lever, which is mounted to the housing through an unlocking lever fixed shaft and is rotatable around the unlocking lever fixed shaft; an electromagnetic drive element that can drive the unlocking lever to rotate in the first direction upon receiving a trigger signal; and an unlocking lever return spring for providing an elastic supporting force to the unlocking lever so that one end of the unlocking lever remains close to or in contact with the electromagnetic drive element.

Preferably, the unlocking assembly comprises: an unlocking lever which is mounted to the housing through the unlocking lever fixed shaft and is rotatable around the unlocking lever fixed shaft; an electromagnetic drive element that can drive the unlocking lever to rotate in the first direction upon receiving a trigger signal; and a unlocking lever return spring for providing an elastic supporting force to the unlocking lever so that one end of the unlocking lever remains close to or in contact with the electromagnetic drive element; wherein the locking assembly comprising a locking part and a tripping part, wherein the tripping part comprises a tripping rod which is mounted to the operating assembly through a tripping rod fixed shaft and is rotatable around the tripping rod fixed shaft, and the tripping rod has a tripping arm; the unlocking lever comprising an unlocking lever body; a first end of the unlocking lever body has a first extension plate extending downward and an unlocking lever push rod extending from a lower end of the first extension plate in a direction away from the unlocking lever body, the unlocking lever push rod being close to or in contact with the electromagnetic drive element; a second end of the unlocking lever body has a second extension plate extending downward and an unlocking lever press rod extending from a lower end of the second extension plate in a direction away from the unlocking lever body, the unlocking lever press rod being able to be close to or in contact with the tripping arm of the tripping rod, and being able to drive the tripping rod to rotate around the tripping rod fixed shaft in the second direction by pressing the tripping arm, thereby unlocking the locking assembly; the unlocking lever body having an unlocking lever stop plate near the first end, and an end of the unlocking lever return spring bearing against the unlocking lever stop plate; the unlocking lever body has a unlocking lever reset protrusion near the second end thereof, wherein when the electromagnetic drive element is in the triggered state, the operating assembly cooperates with the unlocking lever reset protrusion during rotating in the first or second direction, and pushes the unlocking lever to move so as to drive the electromagnetic drive element to complete the reset.

Preferably, the actuator comprises an energy storage element stop plate; the operating assembly comprises said energy storage element, a drive shaft, a drive plate, a sleeve, a deflection torsion spring, and a handle, wherein the sleeve is provided on the actuator; the drive plate is mounted at the top of the sleeve, which can rotate by a predetermined angle relative to the drive plate around an axis of the sleeve; the drive shaft is mounted in the sleeve and fits with the sleeve in a way that allows them to rotate in the same direction, with the top of the drive shaft passing through the top of the housing, and the bottom thereof passing through the bottom of the housing; the handle is mounted to the top of the drive shaft; the deflection torsion spring is provided at the bottom of the sleeve, and connects the sleeve and the actuator and can apply a torsional moment to the sleeve, so that the sleeve can rotate in a direction in which a torsional moment is applied thereto by the deflection torsion spring; the energy storage element is sleeved on the sleeve and has an energy storage element first torsion arm and an energy storage element second torsion arm, wherein the energy storage element first torsion arm bears against the energy storage element stop plate of the actuator to apply a torsional moment in the first direction to the actuator, causing the actuator to rotate around the drive shaft in the direction in which a torsional moment is applied thereto by the energy storage element.

Preferably, the operating assembly comprises a drive plate; the locking assembly comprises a locking part including a locking rod and a tripping part including a tripping rod; the drive plate comprises a plate-shaped drive plate body, which has at an outer edge of thereof a locking rod fixing bent plate and a tripping rod fixing bent plate extending downward, wherein the locking rod is mounted to the locking rod fixing bent plate through a locking rod fixed shaft, and the tripping rod is mounted to the tripping rod fixing bent plate through a tripping rod fixed shaft.

Preferably, the operating assembly comprises a drive shaft, a drive plate, and said energy storage element which has an energy storage element first torsion arm and an energy storage element second torsion arm, wherein the drive plate comprises a plate-shaped drive plate body having: a driving board extending downward, wherein the energy storage element second torsion arm of the energy storage element bears against the driving board to apply a torsional moment in the second direction to the operating assembly, such that the operating assembly has a tendency to rotate or rotate around an axis of the drive shaft in the direction in which a torsional moment is applied thereto by the energy storage element.

Preferably, the locking assembly comprises a locking part including a locking rod that includes a locking rod upper plate and a locking rod lower plate; the drive plate body further has a clearance slide slot; the locking rod torsion spring has a locking rod torsion spring first torsion arm and two locking rod torsion spring second torsion arms; the locking rod torsion spring first torsion arm bears against the locking rod fixing bent plate; one of the two locking rod torsion spring second torsion arms bears against the locking rod upper plate and is inserted into the clearance slide slot of the drive plate body, and can provide a torsional moment to the locking rod upper plate; the other of the two locking rod torsion spring second torsion arms bears against the locking rod lower plate, and can provide a torsional moment to the locking rod lower plate; during rotation of the locking rod around the locking rod fixed shaft, one of the two locking rod torsion spring second torsion arms of the locking rod torsion spring is slidable along the clearance slide slot of the drive plate body to prevent the drive plate from obstructing the torsion of the one of the two locking rod torsion spring second torsion arms.

Preferably, the drive plate comprises a plate-shaped drive plate body which has: at least one limiting slide slot having a predetermined length in a circumferential direction, having a first limiting surface at a first end in the circumferential direction and a second limiting surface at a second end in the circumferential direction, and extending from the first limiting surface to the second limiting surface in the second direction, wherein the sleeve has a sleeve central hole passing through in the vertical direction, and has at its top a sleeve drive protrusion corresponding to the limiting slide slot, each sleeve drive protrusion being inserted into a corresponding limiting slide slot, and the sleeve drive protrusion being slidable along the limiting slide slot, so that the sleeve can rotate by a predetermined angle relative to the drive plate around the drive shaft.

Preferably, the bottom of the sleeve has: a concave hole for accommodating the deflection torsion spring; a clearance groove having a predetermined length in a circumferential direction, having a first clearance end face at a first end in the circumferential direction and a second clearance end face at a second end in the circumferential direction, and extending from the first clearance end face to the second clearance end face in the second direction; and a limiting groove.

Preferably, the deflection torsion spring comprises: a deflection torsion spring first torsion arm that is inserted into a deflection torsion spring limit hole of the actuator body of the actuator after passing through the clearance groove of the sleeve; and a deflection torsion spring second torsion arm that is inserted into the limiting groove of the sleeve and can apply a torsional moment to the sleeve, wherein the deflection torsion spring second torsion arm of the deflection torsion spring is able to apply a torsional moment in the first direction to the sleeve so as to push the handle to deflect from a closing position to a buckle-jumping position; the deflection torsion spring second torsion arm of the deflection torsion spring is able to apply a torsional moment in the second direction to the sleeve so as to push the handle to deflect from an over-twisting angle to an opening position.

Preferably, the housing is further provided with: a first stop that can cooperate with the locking rod fixing bent plate of the drive plate to limit rotation of the drive plate in the direction in which a torsional moment is applied thereto by the energy storage element.

Preferably, the housing is further provided with: a second stop that can cooperate with the driving board of the drive plate to limit rotation of the drive plate in the direction in which a torsional moment is applied thereto by the energy storage element.

Preferably, the housing further comprises a buffer, which is provided on the housing and is used to buffer and restrict the actuator from rotating to a set position when the actuator rotates in the direction in which a torsional moment is applied thereto by the energy storage element under driving of energy release from the energy storage element.

The energy storage mechanism for state switching operation in an electrical control system of the present invention unlocks a locking assembly through an unlocking assembly, thereby releasing the locked state between the operating assembly and the actuator. The operating assembly is limited by the housing and cannot move in the direction in which torsional moment is applied thereto by the energy storage element, so that the actuator is no longer limited by the operating assembly and rotates in another direction under the driving of the energy storage element, executing the opening action of the state switching unit of the electrical control system and achieving free tripping.

The methods and devices of the present invention have other characteristics and advantages that will be apparent from the accompanying drawings and subsequent specific embodiments incorporated herein, or will be described in detail in the accompanying drawings and subsequent specific embodiments, which together serve to explain the specific principles of the present invention.

### BRIEF DESCRIPTION OF DRAWINGS

FIG. 1 is a perspective exploded view of an energy storage mechanism for state switching operation in an electrical control system according to an embodiment of the present invention;

FIG. 2 is a cross-sectional view of an energy storage mechanism for state switching operation in an electrical control system according to an embodiment of the present invention;

FIG. 3 is a schematic view of cooperation between the drive plate and the base;

FIG. 4 is a schematic view of cooperation between the locking rod, the locking rod fixed shaft, and the locking rod fixing bent plate;

FIG. 5 is a schematic view of the first locked state of the locking assembly;

FIG. 6 is a schematic view of the second locked state of the locking assembly;

FIG. 7A is a schematic view of the first state of an energy storage mechanism for state switching operation in an electrical control system;

FIG. 7B is a schematic view of positions of the sleeve and the deflection torsion spring first torsion arm of the deflection torsion spring in FIG. 7A;

FIG. 8A is a schematic view of the second state of an energy storage mechanism for state switching operation in an electrical control system;

FIG. 8B is a schematic view of positions of the sleeve and the deflection torsion spring first torsion arm of the deflection torsion spring in FIG. 8A;

FIG. 9A is a schematic view of the third state of an energy storage mechanism for state switching operation in an electrical control system;

FIG. 9B is a schematic view of positions of the sleeve and the deflection torsion spring first torsion arm of the deflection torsion spring in FIG. 9A;

FIG. 10 is a schematic view of the fourth state of an energy storage mechanism for state switching operation in an electrical control system;

FIG. 11 is a schematic view of the fifth state of an energy storage mechanism for state switching operation in an electrical control system;

FIG. 12 is a schematic view of the sixth state of an energy storage mechanism for state switching operation in an electrical control system;

FIG. 13 is a schematic view of the seventh state of an energy storage mechanism for state switching operation in an electrical control system;

FIG. 14 is a schematic view of the eighth state of an energy storage mechanism for state switching operation in an electrical control system;

FIG. 15 is a schematic view of the ninth state of an energy storage mechanism for state switching operation in an electrical control system;

FIG. 16 is a schematic view of the tenth state of an energy storage mechanism for state switching operation in an electrical control system;

FIG. 17 is a schematic view of the eleventh state of an energy storage mechanism for state switching operation in an electrical control system;

FIG. 18 is a schematic view of the installation of the energy storage element;

FIG. 19A is a schematic view of positions of the deflection torsion spring and the actuator;

FIG. 19B is a schematic view of positions of the deflection torsion spring and the sleeve;

FIG. 20 is a perspective schematic view of the second locked state of the locking assembly;

FIG. 21 is a structural schematic view of the energy storage element;

FIG. 22A is a structural schematic view of the drive plate;

FIG. 22B is a structural schematic view of the drive plate from another perspective;

FIG. 23A is a structural schematic view of the sleeve;

FIG. 23B is a structural schematic view of the sleeve from another perspective;

FIG. 24 is a structural schematic view of the deflection torsion spring;

FIG. 25A is a structural schematic view of the actuator;

FIG. 25B is a structural schematic view of the actuator from another perspective;

FIG. 26A is a structural schematic view of the locking rod;

FIG. 26B is a structural schematic view of the locking rod from another perspective;

FIG. 27 is a structural schematic view of the locking rod torsion spring;

FIG. 28 is a structural schematic view of the tripping rod;

FIG. 29 is a structural schematic view of the tripping rod torsion spring;

FIG. 30 is a structural schematic view of the unlocking lever;

FIG. 31 is a structural schematic view of the rotary shaft;

FIG. 32 is a schematic view of FIG. 3 without the drive plate;

FIG. 33 is a schematic view of cooperation between the tripping rod and the tripping rod torsion spring;

FIG. 34 is a schematic view of the internal structure of an energy storage mechanism for state switching operation in an electrical control system corresponding to FIG. 15;

FIG. 35 is a schematic view I of an energy storage mechanism for state switching operation in an electrical control system according to an embodiment of the present invention without the housing and the handle;

FIG. 36 is a schematic view II of an energy storage mechanism for state switching operation in an electrical control system according to an embodiment of the present invention without the housing and the handle;

FIG. 37 is a schematic view I of the locking assembly;

FIG. 38 is a schematic view II of the locking assembly.

List of reference numerals:

| | |
|---|---|
| 1: housing | 11: base |
| 12: top cover | 13: buffer |
| 14: first stop | 15: second stop |
| 16: handle | |
| 2: operating assembly | |
| 21: energy storage element | |
| 211: energy storage element first torsion arm | |
| 212: energy storage element second torsion arm | |
| 22: drive shaft | 221: rotary shaft |
| 222: pin | 223: sealing ring |
| 224: retaining ring | 225: step |
| 23: drive plate | 231: locking rod fixing bent plate |
| 232: tripping rod fixing bent plate | 233: limiting slide slot |
| 233A: first limiting surface | 233B: second limiting surface |
| 234: drive plate center hole | 235: driving board |
| 236: drive plate body | 237: clearance slide slot |
| 238: drive plate protrusion | |
| 24: sleeve | 241: sleeve center hole |
| 242: sleeve drive protrusion | 243: concave hole |
| 244: clearance groove | 244A: first clearance end face |
| 244B: second clearance end face | |
| 245: limiting groove | |
| 25: deflection torsion spring | |
| 251: deflection torsion spring first torsion arm | |
| 252: deflection torsion spring second torsion arm | |
| 3: actuator | |
| 31: locking protrusion | 32: push plate |
| 33: actuator center hole | 341: energy storage element limit plate |
| 342: energy storage element limit plate | 343: energy storage element limit plate |
| 35: energy storage element stop plate | 36: connection positioning plate |
| 37: deflection torsion spring limit hole | 38: actuator body |
| 4: locking assembly | |
| 41: locking rod | 411: locking rod limit hole |
| 412: locking groove | 413: stop plate |
| 414: locking rod abutment surface | 415: locking rod stop surface |
| 416: locking rod upper plate | 417: locking rod lower plate |
| 418: locking rod connecting plate | |
| 42: locking rod torsion spring | |
| 421: locking rod torsion spring first torsion arm | |
| 422: locking rod torsion spring second torsion arm | |
| 43: tripping rod | 431: tripping rod limit hole |
| 432: tripping rod stop surface | 433: tripping rod abutment surface |
| 434: tripping arm | 435: tripping rod upper plate |
| 436: tripping rod lower plate | 437: tripping rod connecting plate |
| 438: stopping surface | |
| 44: tripping rod torsion spring | |
| 441: first torsion arm of tripping rod torsion spring | |
| 442: second torsion arm of tripping rod torsion spring | |
| 45: locking rod fixed shaft | 46: tripping rod fixed shaft |
| 5: unlocking assembly | |
| 51: electromagnetic drive element | |
| 52: unlocking lever | 521: unlocking lever center hole |
| 522: unlocking lever push rod | 523: unlocking lever press rod |
| 524: unlocking lever reset protrusion | 525: unlocking lever body |
| 526: first extension plate | 527: second extension plate |
| 528: unlocking lever stop plate | |
| 53: unlocking lever return spring | |
| 54: unlocking lever fixed shaft. | |

It should be understood that the accompanying drawings are not necessarily drawn to scale, but rather present simplified representations of various features to illustrate the basic principles of the present invention. The specific design features disclosed in the present invention, including, for example, specific dimensions, directions, positions, and shapes, will be partially determined by the specific application and environment of use.

In these drawings, throughout the multiple figures of the drawings, the same reference numerals refer to the same or equivalent parts of the present invention.

### DETAILED DESCRIPTION OF EMBODIMENTS

Reference will be made in detail to various embodiments of the present invention, examples of which are presented in the accompanying drawings and described below. Although the present invention is described in conjunction with exemplary embodiments, it should be understood that this description is not intended to limit the present invention to these exemplary embodiments. On the contrary, the present invention is intended to cover not only these exemplary embodiments, but also various substitutions, modifications, equivalents, and other embodiments that can be included within the spirit and scope of the present invention as defined by the appended claims.

When a component is referred to as being “above” or “on” another component, the component may be in contact with said another component or there may be an intermediate component.

The clockwise and counterclockwise directions in the embodiments of the present invention are both directions when observing the energy storage mechanism for state switching operation in an electrical control system from top to bottom.

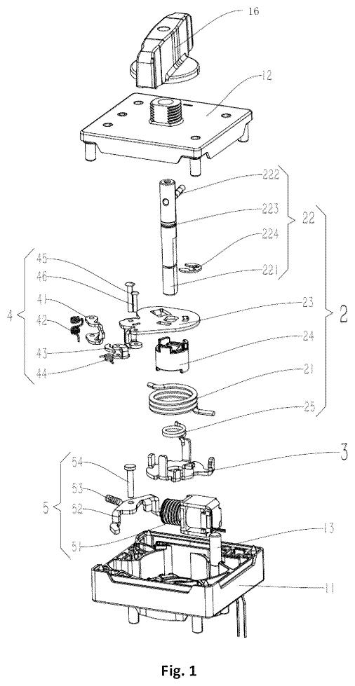

The energy storage mechanism for state switching operation in an electrical control system according to embodiments of the present invention will be described below with reference to FIGS. 1 to 31.

As shown in FIG. 1, the energy storage mechanism for state switching operation in an electrical control system according to an embodiment of the present invention includes: a housing 1, an operating assembly 2, an actuator 3, a locking assembly 4, and an unlocking assembly 5.

The housing 1 is used to carry the operating assembly 2, the actuator 3, the locking assembly 4, and the unlocking assembly 5.

The operating assembly 2 is mounted to the housing 1 and includes an energy storage element 21.

The actuator 3 is connected to a state-switching unit of the electrical control system.

The locking assembly 4 is mounted to the operating assembly 2 or the actuator 3; the energy storage element 21 connects the operating assembly 2 and the actuator 3, and is enabled to store energy by changing a relative position between the operating assembly 2 and the actuator 3, and after the relative position between the operating assembly 2 and the actuator 3 is changed to a predetermined position, the operating assembly 2 is connectable to the actuator 3 through the locking assembly 4 to be in a locked state; the operating assembly 2 is then driven to move in an opposite direction, which drives the actuator 3 to move in the same direction, and the operating assembly 2 drives the actuator 3 to reach a restricted position of the operating assembly 2 restricted by the housing 1, thereby causing the actuator 3 to drive the position state of the state-switching unit of the electrical control system to change.

The unlocking assembly 5 is mounted to the housing 1 or the operating assembly 2 or the actuator 3; the unlocking assembly 5, upon receiving a trigger signal, is capable of releasing the locked state between the operating assembly 2 and the actuator 3, allowing the energy storage element 21 to release stored energy, and the operating assembly 2 is restricted by the housing 1 from moving in a direction in which a force is applied thereto by the energy storage element 21, and the actuator 3 is movable in the direction in which a force is applied thereto by the energy storage element 21 under driving of energy released from the energy storage element 21, thereby driving the position state of the state-switching unit of the electrical control system to change again.

In an embodiment of the present invention, the locking assembly 4 is unlocked through the unlocking assembly, thereby releasing the locked state between the operating assembly 2 and the actuator 3. The operating assembly 2 is restricted by the housing 1 and cannot move in the direction (clockwise direction) in which a torsional force is applied thereto by the energy storage element 21, so that the actuator 3 is no longer restricted by the operating assembly 2 and rotates in another direction (counterclockwise direction) under the drive of the energy storage element 21, executing the opening action of the state-switching unit of the electrical control system and achieving free tripping.

The change in the relative position between the operating assembly 2 and the actuator 3 can be a position of the two along a straight line direction, a relative rotational position, or a position transformation of other forms of paths.

The change here can be made by adjusting only the operating assembly 2, only the actuator 3, or both.

The force applied by the energy storage element 21 to the operating assembly 2 may be a force in a straight line direction, a torsional force in the rotational direction (i.e., torsional moment), or other forms of force in other directions.

In an embodiment of the present invention, the operating assembly 2 is rotated in a first direction (counterclockwise direction) to store energy in the energy storage element 21, and then is rotated in a second direction (clockwise direction) to perform the closing operation.

In another embodiment, it is also possible to rotate the operating assembly 2 in the second direction (clockwise direction) to store energy in the energy storage element 21, and then rotate the operating assembly 2 in the first direction (counterclockwise direction) to perform the closing operation. This situation also applies to motion in a straight line direction or position changes in other forms of paths. That is, the relative position changes in one direction to allow the energy storage element 21 to store energy, and then changes in another direction to perform the closing.

In an exemplary embodiment, as shown in FIGS. 1 to 3, the operating assembly 2 is rotated in the first direction (counterclockwise direction) to change the relative position between the operating assembly 2 and the actuator 3 so that the energy storage element 21 stores energy; after the operating assembly 2 is rotated to a predetermined position relative to the actuator 3, the operating assembly 2 is connectable with the actuator 3 via the locking assembly 4 to be in a locked state; then the operating assembly 2 is rotated in the second direction (clockwise direction), and drives the actuator 3 to rotate in the second direction (clockwise direction), and the operating assembly 2 causes the actuator 3 to reach a restricted position where the operating assembly 2 is restricted by the housing 1, which further causes the actuator 3 to drive the position state of the state-switching unit of the electrical control system to change.

In an exemplary embodiment, the operating assembly 2 and the actuator 3 are locked by the locking assembly 4, so as to be combined as a whole and movable together, and the energy storage element 21 connected between the operating assembly 2 and the actuator 3 stores energy which can force the relative position between the operating assembly 2 and the actuator 3 to have a tendency to move away, or can force the relative position between the operating assembly 2 and the actuator 3 to have a tendency to move closer.

The moving away or closer herein may be moving away or closer in a straight line direction, or in the process of relative rotation, the contact position between the energy storage element 21 and the operating assembly 2 (i.e., the energy storage element stop plate 35 of the actuator 3 that the energy storage element first torsion arm 211 of the energy storage element 21 contacts, as described later) and the contact position between the energy storage element 21 and the actuator 3 (i.e., the driving board 235 of the drive plate 23 of the operating assembly 2 that the energy storage element second torsion arm 212 of the energy storage element 21 contacts, as described later) may move away or closer in a circumferential direction, or it may be moving away or closer in other forms of paths.

In the exemplary embodiment, as shown in FIG. 1, the housing 1 includes a base 11 and a top cover 12, which form a receiving cavity.

In the exemplary embodiment, as shown in FIG. 1, the housing 1 further comprises a buffer 13 arranged on the base 11. When the energy storage element 21 releases energy and drives the actuator 3 to rotate in the first direction (counterclockwise direction), the buffer 13 can buffer and stop the actuator 3 to restrict its rotation in the first direction (counterclockwise direction) and keep it in the opening position.

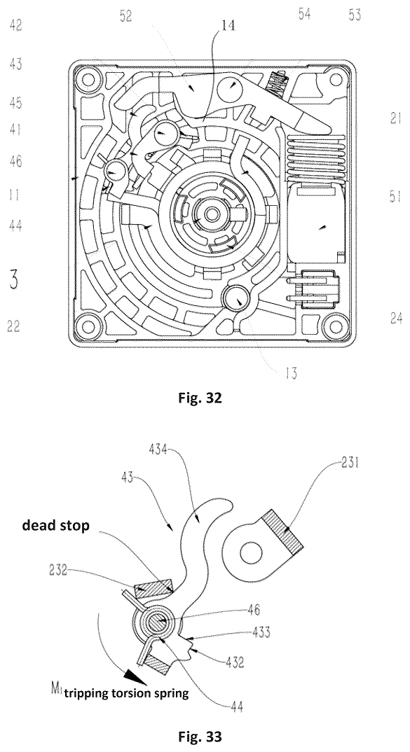

In the exemplary embodiment, as shown in FIGS. 3 and 32, the base 11 is provided with a first stop 14 that can stop the locking rod fixing bent plate 231 of the drive plate 23 described later to restrict the rotation of the drive plate 23 in the second direction (clockwise direction), and a second stop 15 that can stop the driving board 235 of the drive plate 23 described later to restrict the rotation of the drive plate 23 in the second direction (clockwise direction). The dual limiting structure of the first stop 14 and the second stop 15 can achieve stable limiting.

In FIG. 3, 2 stops are provided, and the number of stops can be adjusted according to actual requirements, such as 1, 3 or even more.

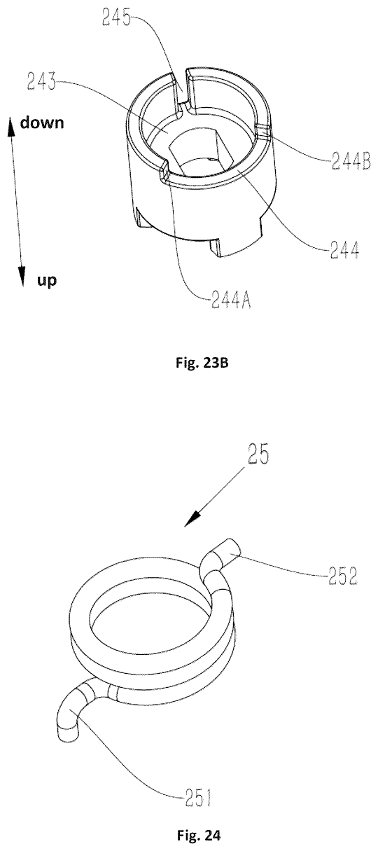

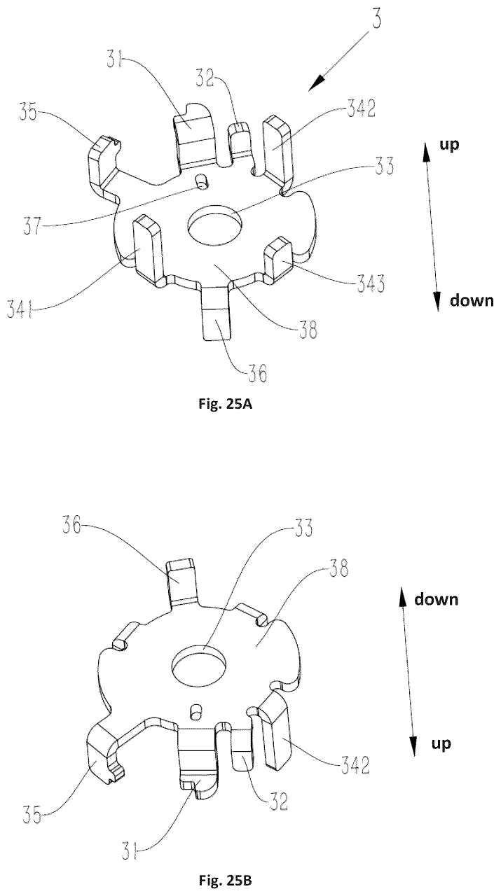

In the exemplary embodiment, as shown in FIGS. 25A and 25B, the actuator 3 includes an actuator body 38 having a plate shape and having an actuator center hole 33 through which the drive shaft 22, which will be described later, can pass. The actuator body 38 is rotatably installed in the base 11.

The outer edge of the actuator body 38 has three energy storage element limit plates extending upward, namely an energy storage element limit plate 341, an energy storage element limit plate 342, and an energy storage element limit plate 343. One of the three energy storage element limit plates, the energy storage element limit plate 343, is located on the first side of the energy storage element limit plates 341, 342.

The energy storage element limit plates 341, 342, and 343 are used to limit the position of the energy storage element 21, which will be described later, to prevent significant offset of the energy storage element 21 during the energy storage process.

The outer edge of the actuator body 38 also sequentially has a push plate 32, a locking protrusion 31, and an energy storage element stop plate 35 extending upward, wherein the push plate 32, the locking protrusion 31, and the energy storage element stop plate 35 are located on the second side of the energy storage element limit plates 341, 342.

The locking protrusion 31 can be locked with a locking groove 412 of the locking rod 41 described later.

The push plate 32 is contactable with a stop plate 413 of the locking rod 41 in the locking assembly 4 described later, and can force the locking rod 41 to rotate around the locking rod fixed shaft 45 in the first direction (counterclockwise direction) after contact.

The energy storage element stop plate 35 is used to cooperate with the buffer 13, so that the actuator 3 is in a stationary state relative to the housing 1. The energy storage element first torsion arm 211 of the energy storage element 21, which will be described later, bears against the energy storage element stop plate 35 to apply a torsional moment to the energy storage element stop plate 35 of the actuator 3 in the first direction (counterclockwise direction), thereby driving the actuator 3 to rotate in the first direction (counterclockwise direction).

The outer edge of the actuator body 38 also has a connection positioning plate 36 extending downward, which is located between the energy storage element limit plate 343 and the energy storage element limit plate 341.

The connection positioning plate 36 extends downward from the base 11 so as to be connected to the state-switching unit of the electrical control system.

The actuator body 38 also has a deflection torsion spring limit hole 37, and the deflection torsion spring first torsion arm 251 of the deflection torsion spring 25, which will be described later, is inserted into the deflection torsion spring limit hole 37.

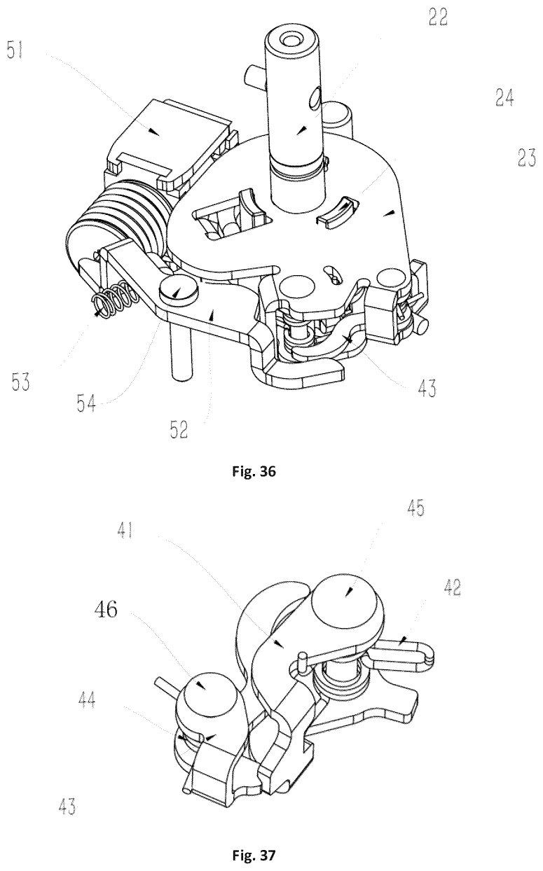

In the exemplary embodiment, as shown in FIGS. 1, 35, and 36, the unlocking assembly 5 comprises an electromagnetic drive element 51, an unlocking lever 52, an unlocking lever return spring 53, and an unlocking lever fixed shaft 54.

The electromagnetic drive element 51 is installed in the base 11, and is electrically connected to an external circuit and is capable of receiving trigger signals from the external circuit. After receiving a trigger signal, the electromagnetic drive element 51 can drive the unlocking lever 52 to rotate around the locking rod fixed shaft 45 in the first direction (counterclockwise direction).

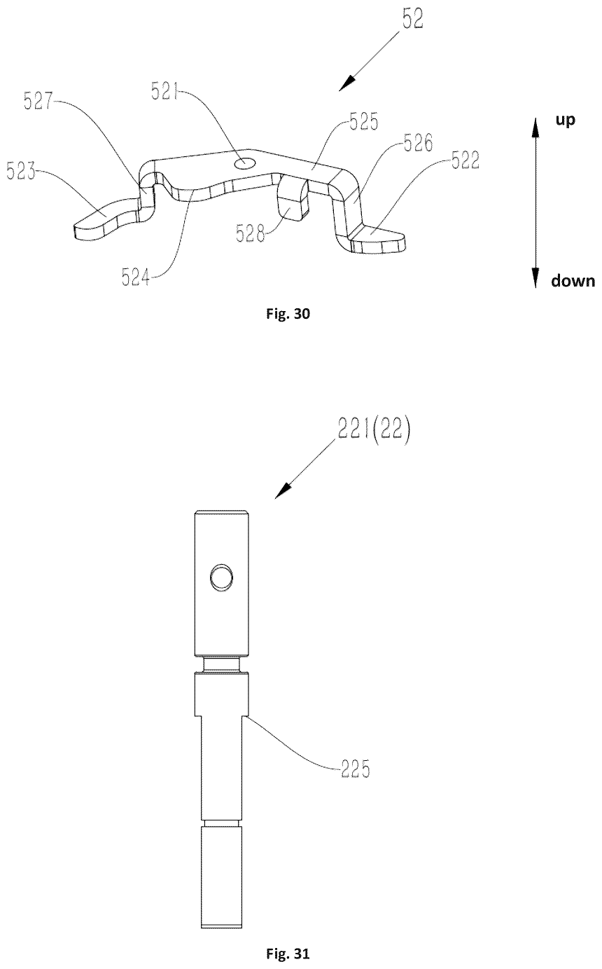

As shown in FIG. 30, the unlocking lever 52 includes an unlocking lever body 525, which has an unlocking lever center hole 521 for the unlocking lever fixed shaft 54 to pass through. The unlocking lever 52 is rotatably installed in the base 11 through the unlocking lever fixed shaft 54 (i.e., the rotation center of the unlocking lever 52 is the unlocking lever fixed shaft 54).

The first end of the unlocking lever body 525 has a first extension plate 526 extending downward and an unlocking lever push rod 522 extending from the lower end of the first extension plate 526 in a direction away from the unlocking lever body 525. The unlocking lever push rod 522 is close to or in contact with the electromagnetic drive element 51 and can be pushed by the electromagnetic drive element 51. Similarly, the electromagnetic drive element 51 can also be pushed to reset the electromagnetic drive element 51 after unlocking has been triggered.

The second end of the unlocking lever body 525 has a second extension plate 527 extending downward and an unlocking lever press rod 523 extending from the lower end of the second extension plate 527 in a direction away from the unlocking lever body 525. The unlocking lever press rod 523 can approach or come into contact with the tripping arm 434 of the tripping rod 43, and can drive the tripping rod 43 to rotate around the tripping rod fixed shaft 46 in the second direction (clockwise direction) by pressing the tripping arm 434, thereby unlocking the locking assembly 4.

When the unlocking lever 52 rotates in the first direction (counterclockwise direction), the unlocking lever press rod 523 can push the tripping arm 434 of the tripping rod 43 described later.

The unlocking lever body 525 is provided with an unlocking lever stop plate 528 near its first end, and one end of the unlocking lever return spring 53 bears against the unlocking lever stop plate.

The unlocking lever body 525 is provided with an unlocking lever reset protrusion 524 near its second end. When the drive plate 23 described later rotates in the first direction (counterclockwise direction), it can push the unlocking lever reset protrusion 524, causing the unlocking lever 52 to rotate around the unlocking lever fixed shaft 54 in the second direction (clockwise direction), so as to reset the electromagnetic drive element 51 after unlocking has been triggered. Alternatively, when the drive plate 23 described later rotates in the second direction (clockwise direction), it can also push the unlocking lever reset protrusion 524, causing the unlocking lever 52 to rotate around the unlocking lever fixed shaft 54 in the second direction (clockwise direction), so as to reset the electromagnetic drive element 51 after unlocking has been triggered.

The unlocking lever return spring 53 provides elastic supporting force to the unlocking lever 52, so that the unlocking lever push rod 522 of the unlocking lever 52 is kept close to or in contact with the electromagnetic drive element 51, and that the unlocking lever 52 is prevented from rotating.

In the exemplary embodiment, as shown in FIG. 1, the operating assembly 2 comprises an energy storage element 21, a drive shaft 22, a drive plate 23, a sleeve 24, and a deflection torsion spring 25.

The energy storage element 21 is a torsion spring accumulator or a coiled spring accumulator.

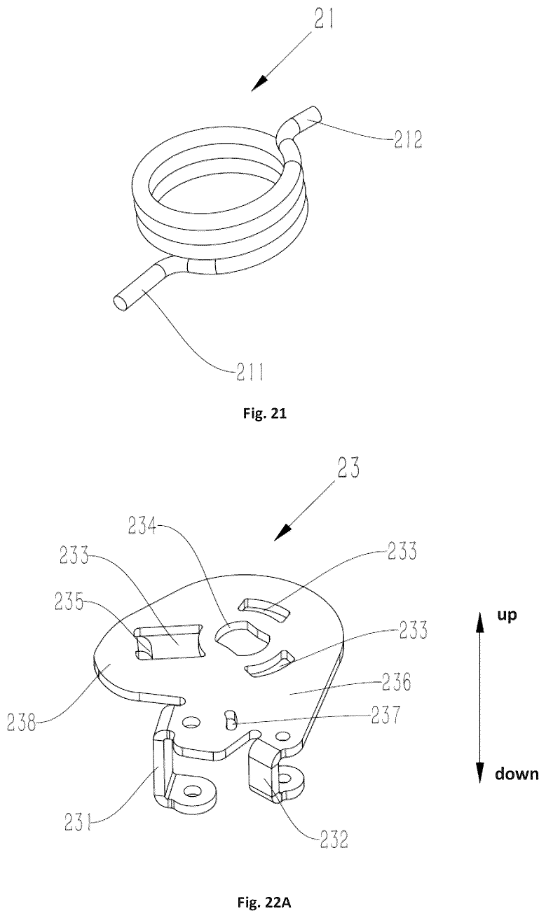

The energy storage element 21 is sleeved on the sleeve 24 and has an energy storage element first torsion arm 211 and an energy storage element second torsion arm 212 extending radially outward (see FIG. 21).

The energy storage element first torsion arm 211 bears against the energy storage element stop plate 35 of the actuator 3, and can apply a torsional moment to the energy storage element stop plate 35 of the actuator 3 in the first direction (counterclockwise direction), so that the actuator 3 rotates around the drive shaft 22 in the first direction (counterclockwise direction).

The energy storage element second torsion arm 212 bears against the driving board 235 of the drive plate 23, which will be described later, and is twistable under the drive of the drive plate 23, so that the energy storage element 21 can store energy. At the same time, the energy storage element second torsion arm 212 can apply a torsional moment in the second direction (clockwise direction) to the driving board 235 of the drive plate 23.

The drive shaft 22 passes through the top cover 12, the drive plate 23, the sleeve 24, the deflection torsion spring 25, the actuator center hole 33 of the actuator body 38 of the actuator 3, and the base 11 in sequence from top to bottom.

The top of the drive shaft 22 is equipped with a handle 16, and the user drives the drive shaft 22 through the handle 16 to rotate around its own axis.

As shown in FIG. 1, the drive shaft 22 includes a rotary shaft 221, a pin 222, a sealing ring 223, and a retaining ring 224.

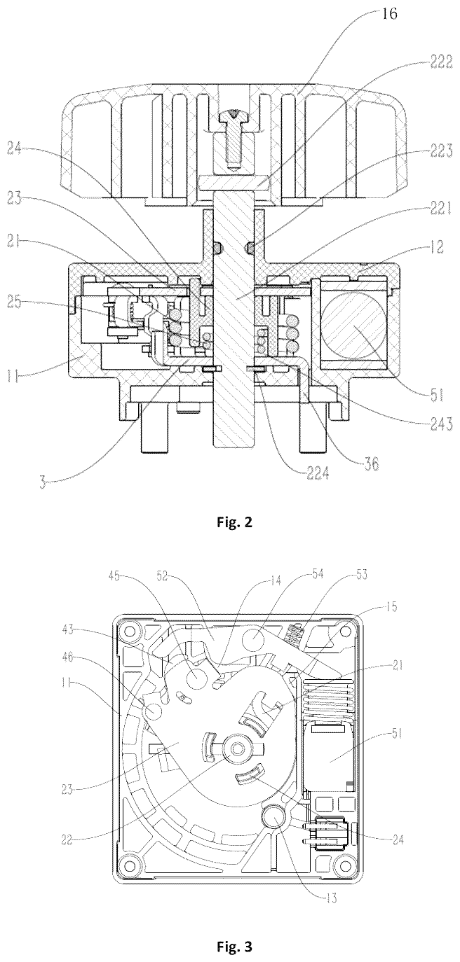

As shown in FIG. 2, the rotary shaft 221 is the main structure of the drive shaft 22, which passes through the top cover 12, the drive plate 23, the sleeve 24, the deflection torsion spring 25, the actuator center hole 33 of the actuator body 38 of the actuator 3, and the base 11 in sequence from top to bottom. The rotary shaft 221 is connected to the handle 16 through the pin 222.

As shown in FIG. 2, the sealing ring 223 is disposed on the rotary shaft 221 and is fitted with the rotary shaft mounting hole disposed in the top cover 12 to achieve a sealing effect between the rotary shaft 221 and the top cover 12. The retaining ring 224 is provided between the rotary shaft 221 and the base 11, and limits the actuator 3 in the axial direction to limit the actuator 3 from moving downward.

As shown in FIGS. 22A and 22B, the drive plate 23 includes a plate-shaped drive plate body 236. The sleeve 24 supports the drive plate 23. The outer edge of the drive plate body 236 has a locking rod fixing bent plate 231 and a tripping rod fixing bent plate 232 extending downward. The locking rod fixing bent plate 231 is used to install the locking rod 41, which will be described later, and the tripping rod fixing bent plate 232 is used to install the tripping rod 43, which will be described later.

The drive plate body 236 also has three limiting slide slots 233, a drive plate center hole 234, and a driving board 235 extending downward from one of the limiting slide slots 233. The driving board 235 may not extend downward from the limiting slide slot 233, but may also extend downward from other positions.

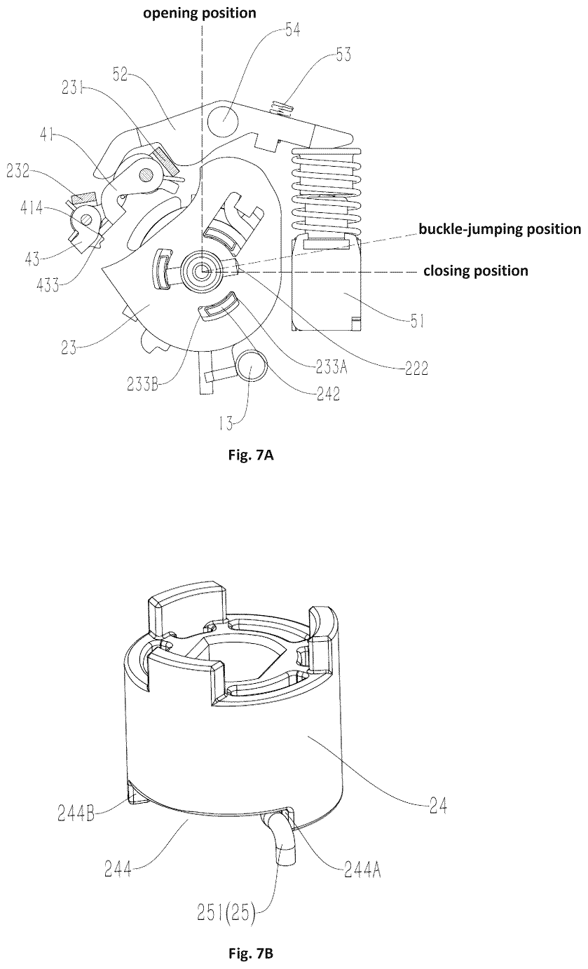

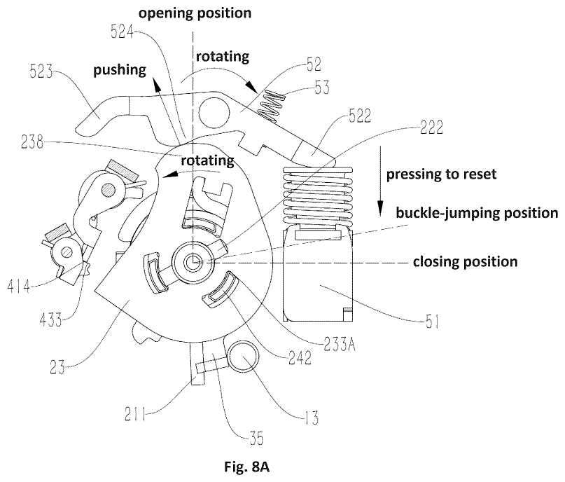

The limiting slide slot 233 has a predetermined length in the circumferential direction. The limiting slide slot 233 has a first limiting surface 233A at the first end in the circumferential direction, and a second limiting surface 233B at the second end in the circumferential direction, and extends from the first limiting surface 233A to the second limiting surface 233B in the first direction (counterclockwise direction) (see FIG. 7A). The number of the limiting slide slots 233 can be adjusted according to actual requirements, for example, it can be set to any number between 1 and 6.

A sleeve driving protrusion 242 of the sleeve 24, which will be described later, is inserted into a respective limiting slide slot 233. The sleeve driving protrusion 242 is slidable along the limiting slide slot 233, so that the sleeve 24 is rotatable by a predetermined angle around the drive shaft 22 relative to the drive plate 23, thereby achieving deflection indication of the handle.

The drive plate center hole 234 is intended for the rotary shaft 221 of the drive shaft 22 to pass through.

When the driving board 235 rotates in the first direction (counterclockwise direction), the driving board 235 can push the energy storage element second torsion arm 212 to twist, causing the energy storage element 21 to store energy.

The drive plate body 236 further has a clearance slide slot 237, through which one of the locking rod torsion spring second torsion arms 422 described later can pass, so that the one of the locking rod torsion spring second torsion arms 422 of the locking rod torsion spring 42 slides along the clearance slide slot 237, thereby avoiding the drive plate 23 from obstructing the torsion of the locking rod torsion spring second torsion arm 422.

The drive plate body 236 also has a drive plate protrusion 238. During the rotation of the drive plate 23 in the first direction (counterclockwise direction), the drive plate protrusion 238 can push the unlocking lever reset protrusion 524, causing the unlocking lever 52 to rotate around the unlocking lever fixed shaft 54 in the second direction (clockwise direction).

In the exemplary embodiment, as shown in FIG. 2, the sleeve 24 is sleeved on the rotary shaft 221 of the drive shaft 22 and rotates synchronously with the drive shaft 22.

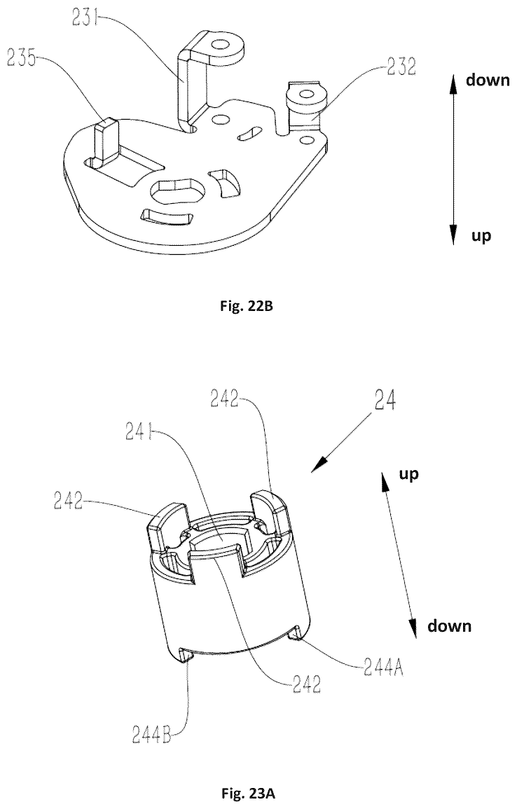

As shown in FIG. 23A, the sleeve 24 has a sleeve center hole 241 that passes through in the vertical direction. The top of the sleeve 24 has three sleeve drive protrusions 242, each of which is inserted into a respective limiting slide slot 233 of the drive plate 23. The sleeve drive protrusion 242 is slidable along the limiting slide slot 233, so that the sleeve 24 is rotatable by a predetermined angle relative to the drive plate 23 around the axis of the drive shaft 22, thereby achieving deflection indication of the handle.

The number of the limiting slide slots 233 can be adjusted according to actual requirements, for example, it can be set to any number between 1 and 6.

As shown in FIG. 23B, the bottom of the sleeve 24 has a concave hole 243, a clearance groove 244, and a limiting groove 245.

The concave hole 243 is intended for accommodating the deflection torsion spring 25.

The clearance groove 244 is used to accommodate the deflection torsion spring first torsion arm 251 of the deflection torsion spring 25, which will be described later (see FIG. 19B), and the limiting groove 245 is used to accommodate the deflection torsion spring second torsion arm 252 of the deflection torsion spring 25, which will be described later (see FIG. 19B). The clearance groove 244 has a predetermined length in the circumferential direction, has a first clearance end face 244A at the first end in the circumferential direction and a second clearance end face 244B at the second end in the circumferential direction, and extends from the first clearance end face 244A to the second clearance end face 244B in the second direction (clockwise direction) (see FIGS. 23A and 23B). The deflection torsion spring first torsion arm 251 of the deflection torsion spring 25 is slidable along the clearance groove 244.

As shown in FIG. 2, the deflection torsion spring 25 is installed in the concave hole 243 of the sleeve 24. As shown in FIG. 24, the deflection torsion spring 25 has a deflection torsion spring first torsion arm 251 and a deflection torsion spring second torsion arm 252.

The deflection torsion spring first torsion arm 251 is inserted into the deflection torsion spring limit hole 37 of the actuator body 38 of the actuator 3 after passing through the clearance groove 244 of the sleeve 24 (see FIG. 19A).

The set angle of the clearance groove 244 is larger than the movable range of the deflection torsion spring first torsion arm 251, leaving a clearance margin, that is, the deflection torsion spring first torsion arm 251 will not contact the first clearance end face 244A and the second clearance end face 244B, so that there is a space for movement of the deflection torsion spring first torsion arm 251.

The deflection torsion spring second torsion arm 252 is inserted into the limiting groove 245 of the sleeve 24 and can apply a torsional moment to the sleeve 24.

As shown in FIG. 2, the base 11 supports the actuator 3, the actuator 3 supports the sleeve 24, and the sleeve 24 supports the drive plate 23. The sleeve 24 can transmit the torsional moment of drive shaft 22 to the drive plate 23.

As shown in FIG. 31, a step 225 is provided on the rotary shaft 221 of the drive shaft 22, and the drive plate 23 is arranged below the step 225 which can restrict the upward movement of the drive plate 23 in the axial direction.

The combination of the step 225 and the retaining ring 224 of the drive shaft 22 restricts the axial movement of the actuator 3, the deflection torsion spring 25, the sleeve 24, and the drive plate 23.

In the exemplary embodiment, the locking assembly 4 includes a locking part and a tripping part. By changing the position state of the locking part, the connection between the operating assembly 2 and the actuator 3 is achieved so as to be in a locked state, thereby allowing the operating assembly 2 to move in the same direction as the actuator 3, and causing the position state of the state-switching unit of the electrical control system to change.

Or, by changing the position state of the tripping part via the unlocking assembly 2, the locked state between the operating assembly 2 and the actuator 3 is released, thereby allowing the energy storage element 21 to release energy and drive the actuator 3 to move.

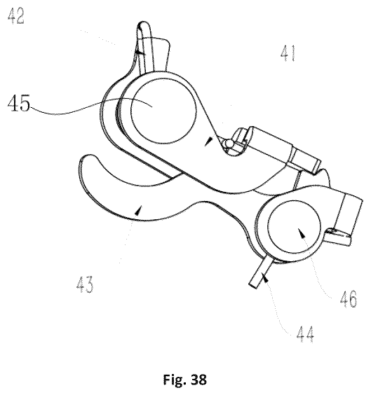

In the exemplary embodiment, as shown in FIGS. 1, 37, and 38, the locking assembly 4 includes a locking rod 41, a locking rod torsion spring 42, a tripping rod 43, a tripping rod torsion spring 44, a locking rod fixed shaft 45, and a tripping rod fixed shaft 46. The locking rod 41 and the locking rod torsion spring 42 form a locking part, while the tripping rod 43 and the tripping rod torsion spring 44 form a tripping part.

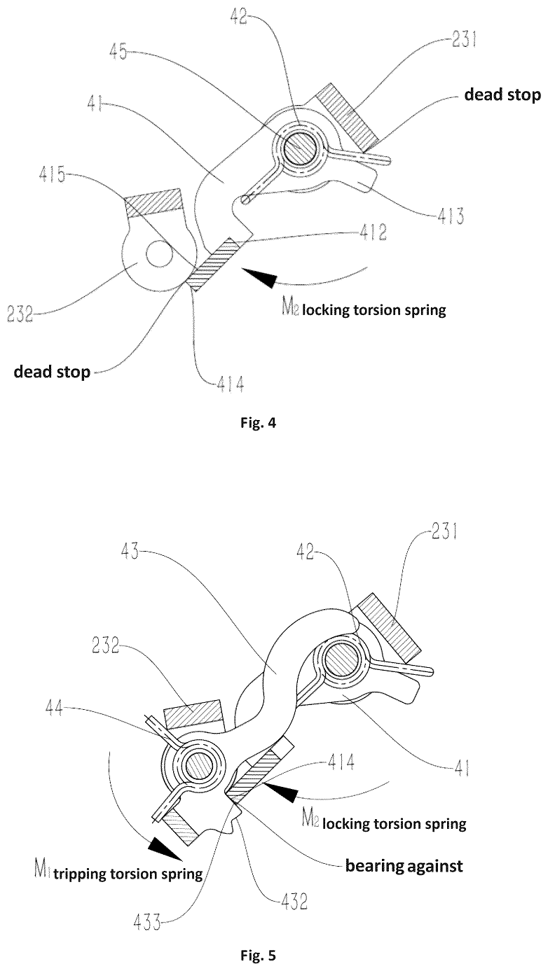

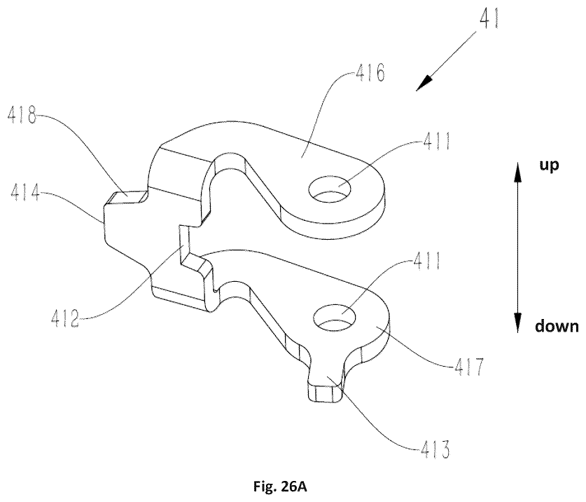

As shown in FIG. 4, the locking rod 41 is installed to the locking rod fixing bent plate 231 through the locking rod fixed shaft 45, and is rotatable around the locking rod fixed shaft 45. As shown in FIG. 26A, the locking rod 41 includes a horizontal locking rod upper plate 416 and locking rod lower plate 417, and a vertical locking rod connecting plate 418. The locking rod upper plate 416 is connected to the locking rod lower plate 417 through the locking rod connecting plate 418.

The locking rod upper plate 416 and locking rod lower plate 417 each has a locking rod limit hole 411, which allows the locking rod fixed shaft 45 to pass through.

The locking rod lower plate 417 has a stop plate 413, which is contactable with the push plate 32 of the actuator 3 and can force the locking rod 41 to rotate in the first direction (counterclockwise direction) around the locking rod fixed shaft 45 after contact.

The end face of the locking rod connecting plate 418 facing the locking rod limit hole 411 has a locking groove 412, and the end face of the locking rod connecting plate 418 away from the locking rod limit hole 411 is a locking rod abutment surface 414. The locking rod connecting plate 418 further has a locking rod stop surface 415 facing away from the stop plate 413 (see FIG. 26B).

The locking groove 412 can cooperate with the locking protrusion 31 of the actuator 3 to be locked.

The locking rod abutment surface 414 of the locking rod 41 can form a bearing state with a tripping rod abutment surface 433 of the tripping rod lower plate 436 of the tripping rod 43, which will be described later, thereby reaching the first locked state.

The locking rod stop surface 415 of the locking rod 41 can cooperate with the tripping rod stop surface 432 of the tripping rod 43, which will be described later, to form a bearing state.

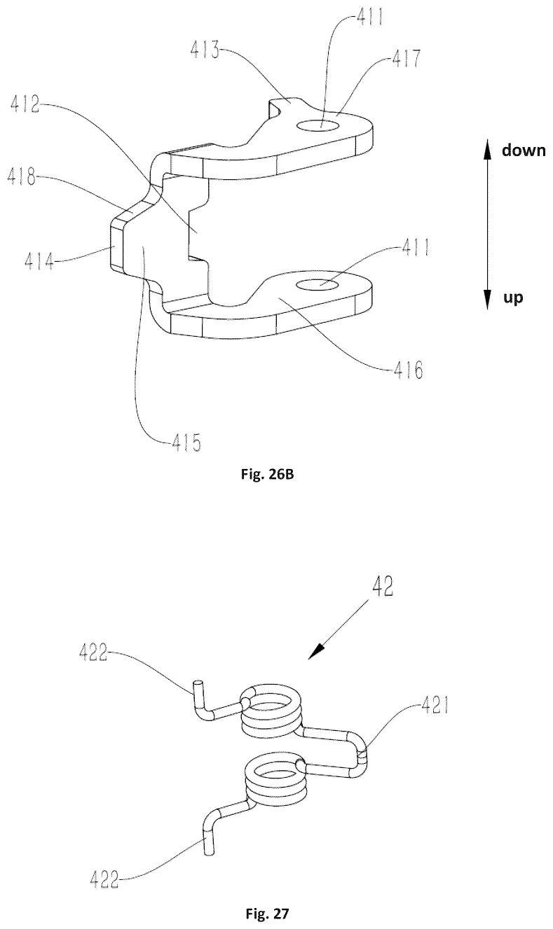

The locking rod torsion spring 42 is installed to the locking rod fixed shaft 45, as shown in FIG. 27, and has a locking rod torsion spring first torsion arm 421 and two locking rod torsion spring second torsion arms 422.

The locking rod torsion spring first torsion arm 421 bears against the locking rod fixing bent plate 231.

One of the two locking rod torsion spring second torsion arms 422 bears against the locking rod upper plate 416 and is inserted into the clearance slide slot 237 of the drive plate 23, and can provide a torsional moment to the locking rod upper plate 416, and the other of the two locking rod torsion spring second torsion arms 422 bears against the locking rod lower plate 417, and can provide a torsional moment to the locking rod lower plate 417. During the rotation of the locking rod 41 around the locking rod fixed shaft 45, one of the two locking rod torsion spring second torsion arms 422 of the locking rod torsion spring 42 is slidable along the clearance slide slot 237 of the drive plate 23 to prevent the drive plate 23 from obstructing the torsion of one of the two locking rod torsion spring second torsion arms 422 of the locking rod torsion spring 42.

The locking rod torsion spring 42 can apply a torsional moment to the locking rod 41, causing the locking rod 41 to rotate in the second direction (clockwise direction), or causing the locking rod 41 to have a tendency to rotate in the second direction (clockwise direction).

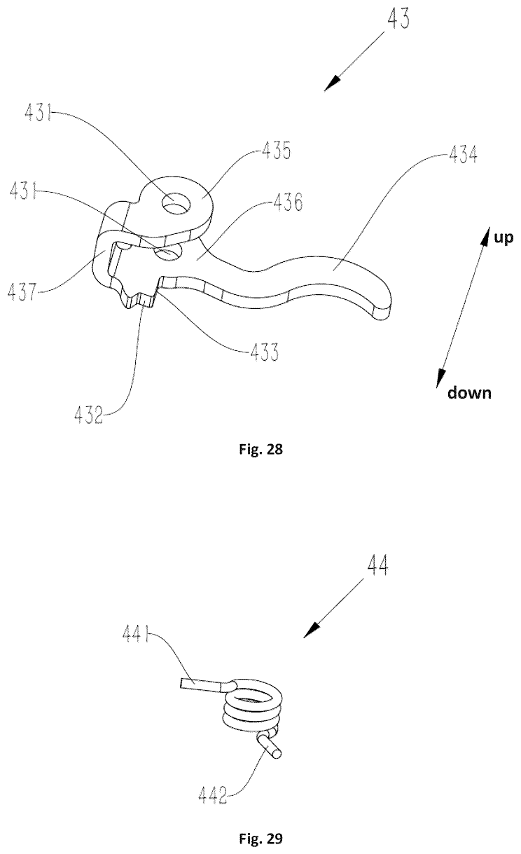

The tripping rod 43 is installed to the tripping rod fixing bent plate 232 (see FIG. 33) through the tripping rod fixed shaft 46, and is rotatable around the tripping rod fixed shaft 46. As shown in FIG. 28, the tripping rod 43 includes a horizontal tripping rod upper plate 435 and tripping rod lower plate 436, and a vertical tripping rod connecting plate 437. The tripping rod upper plate 435 is connected to the tripping rod lower plate 436 through the tripping rod connecting plate 437. The height of the tripping rod upper plate 435 of the tripping rod 43 is approximately level with the height of the locking rod upper plate 416 of the locking rod 41, and the height of the tripping rod lower plate 436 of the tripping rod 43 is located between the height of the locking rod upper plate 416 of the locking rod 41 and the height of the locking rod lower plate 417 of the locking rod 41.

The tripping rod upper plate 435 and tripping rod lower plate 436 each has a tripping rod limit hole 431 which allows the tripping rod fixed shaft 46 to pass through.

The tripping rod lower plate 436 has a tripping rod stop surface 432 and a tripping rod abutment surface 433.

The tripping rod stop surface 432 is used to cooperate with the locking rod stop surface 415 on the locking rod 41 to form a bearing state, in which state, the operating assembly 2 is locked with the actuator 3 through the locking assembly 4 to form an interlocking structure, that is, the second locked state.

The tripping rod abutment surface 433 of the tripping rod lower plate 436 of the tripping rod 43 forms a bearing state with the locking rod abutment surface 414 of the locking rod 41, thereby achieving the second locked state.

The tripping rod lower plate 436 also has a tripping arm 434. When the unlocking lever 52 rotates in the first direction (counterclockwise), the unlocking lever press rod 523 of the unlocking lever 52 can push the tripping arm 434 of the tripping rod 43, causing the tripping rod 43 to rotate around the tripping rod fixed shaft 46 in the second direction (clockwise).

During the rotation of the tripping rod 43 around the tripping rod fixed shaft 46 in the second direction (clockwise direction), the tripping rod 43 can twist the tripping rod torsion spring 44, allowing the tripping rod torsion spring 44 to store energy.

During the rotation of the tripping rod 43 around the tripping rod fixed shaft 46 in the second direction (clockwise direction), the tripping rod 43 can be released from bearing against the locking rod 41.

The tripping rod torsion spring 44 is installed to the tripping rod fixed shaft 46, as shown in FIG. 29, and has a tripping rod torsion spring first torsion arm 441 and a tripping rod torsion spring second torsion arm 442.

The tripping rod torsion spring first torsion arm 441 bears against the tripping rod fixing bent plate 232, and the tripping rod torsion spring second torsion arm 442 bears against the tripping rod connecting plate 437 of the tripping rod 43, and can apply a torsional moment to the tripping rod 43. That is, the tripping rod torsion spring 44 can apply a torsional moment to the tripping rod 43, causing the tripping rod 43 to rotate in the first direction (counterclockwise direction), or causing the tripping rod 43 to have a tendency to rotate in the first direction (counterclockwise direction).

There are two locked states between the actuator 3 and locking assembly 4:

### First Locked State:

The tripping rod abutment surface 433 of the tripping rod lower plate 436 of the tripping rod 43 forms a bearing state with the locking rod abutment surface 414 of the locking rod 41 (see FIG. 5), that is, the locked state between the locking rod 41 and the tripping rod 43. At this time, the locking protrusion 31 of the actuator 3 is not locked with the locking groove 412 of the locking rod 41.

### Second Locked State:

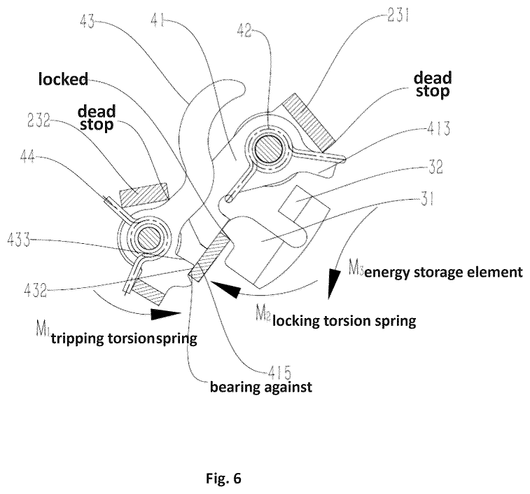

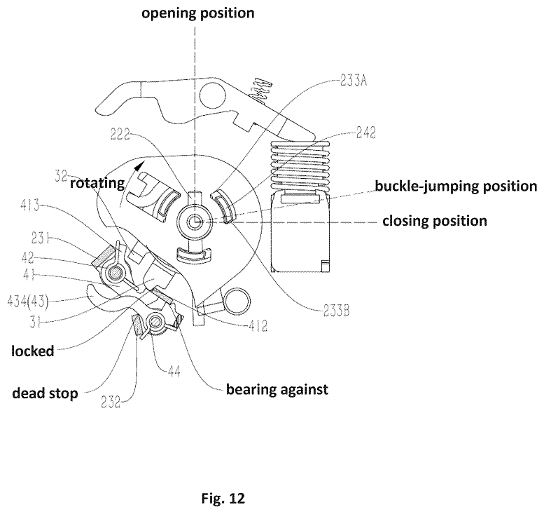

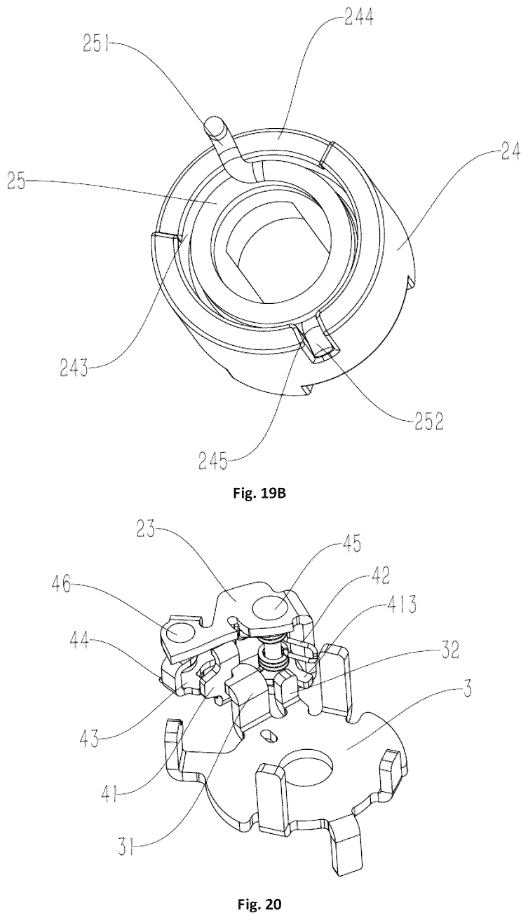

The tripping rod stop surface 432 of the tripping rod lower plate 436 of the tripping rod 43 forms a bearing state with the locking rod stop surface 415 of the locking rod 41 (see FIG. 6 and FIG. 20). The locking protrusion 31 of the actuator 3 is located in the locking groove 412 of the locking rod 41, and the locking protrusion 31 of the actuator 3 cooperates with the locking groove 412 of the locking rod 41 to be locked (see FIG. 12), that is, the locked state among the locking rod 41, the tripping rod 43, and the actuator 3 is achieved, so that the actuator 3 can be connected to the operating assembly 2 through the locking assembly 4 to be in a locked state.

There are two energy storage states for the deflection torsion spring 25:

One is a reverse torsion (direction of expansion in the torsion spring) energy storage state, in which the deflection torsion spring first torsion arm 251 and the deflection torsion spring second torsion arm 252 have a tendency to contract inward, that is, the deflection torsion spring first torsion arm 251 applies a torsional moment in the second direction (clockwise direction) to the actuator 3, and the deflection torsion spring second torsion arm 252 of the deflection torsion spring 25 applies a torsional moment in the first direction (counterclockwise direction) to the sleeve 24.

The other is a forward torsion (direction of contraction in the torsion spring) energy storage state, in which the deflection torsion spring first torsion arm 251 and the deflection torsion spring second torsion arm 252 have a tendency to expand outward, that is, the deflection torsion spring first torsion arm 251 applies a torsional moment in the first direction (counterclockwise direction) to the actuator 3, and the deflection torsion spring second torsion arm 252 of the deflection torsion spring 25 applies a torsional moment in the second direction (clockwise direction) to the sleeve 24.

The operation of the energy storage mechanism for state switching operation in an electrical control system according to embodiments of the present invention will be described below with reference to the accompanying drawings.

Before re-buckling energy storage, the state of the energy storage mechanism for state switching operation of the electrical control system is shown in FIG. 7A. The tripping rod abutment surface 433 of the tripping rod lower plate 436 of the tripping rod 43 forms a bearing state with the locking rod abutment surface 414 of the locking rod 41, and the locking protrusion 31 of the actuator 3 is not locked with the locking groove 412 of the locking rod 41, that is, the first locked state. Moreover, the sleeve drive protrusion 242 of the sleeve 24 is in contact with the first limiting surface 233A. The energy storage element stop plate 35 of the actuator 3 is in contact with the buffer 13 on the base 11, and the actuator 3 is in the opening position.

The deflection torsion spring 25 is in the reverse torsion (direction of expansion in the torsion spring) energy storage state (at this time, the energy storage is the energy stored after the free tripping process is completed), the deflection torsion spring first torsion arm 251 is in a position close to the first clearance end face 244A (see FIG. 7B), the deflection torsion spring first torsion arm 251 applies a torsional moment in the second direction (clockwise direction) to the actuator 3, and the deflection torsion spring second torsion arm 252 of the deflection torsion spring 25 applies a torsional moment in the first direction (counterclockwise direction) to the sleeve 24 to push the corresponding handle 16 to deflect a certain angle, that is, to deflect to a buckle-jumping position.

The energy storage element 21 is in a pre-tightened state, and the energy storage element first torsion arm 211 of the energy storage element 21 applies a torsional moment in the first direction (counterclockwise direction) to the energy storage element stop plate 35 of the actuator 3, and the energy storage element second torsion arm 212 of the energy storage element 21 applies a torsional moment in the second direction (clockwise direction) to the driving board 235 of the drive plate 23.

In the embodiment of FIG. 7A, the direction indicated by the pin 222 is the direction of the handle 16.

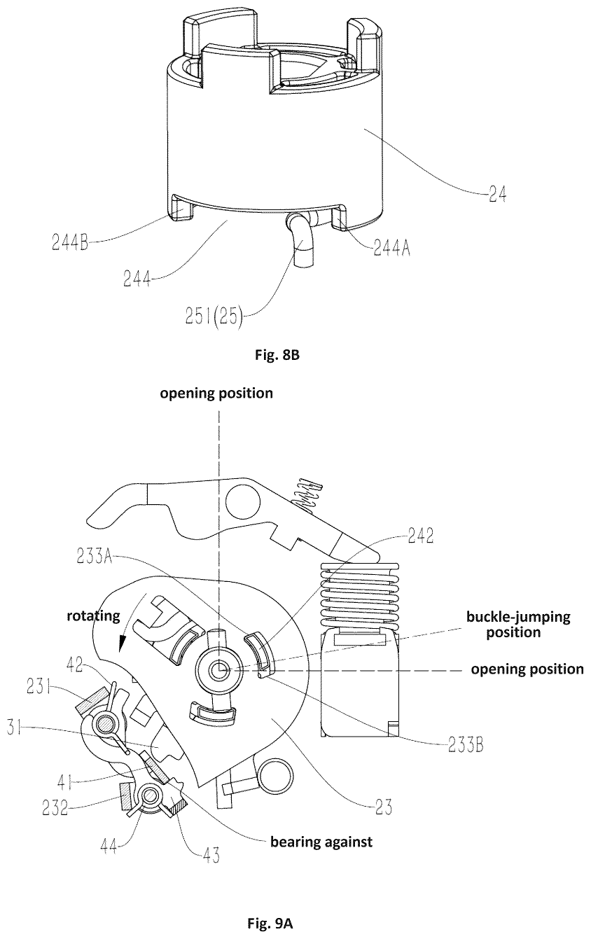

A re-buckling energy storage process:
The handle 16 is manually rotated in the first direction (counterclockwise direction), which drives the drive shaft 22 to rotate in the first direction (counterclockwise direction) to push the sleeve 24 to rotate in the first direction (counterclockwise direction), thereby pushing the drive plate 23 to rotate in the first direction (counterclockwise direction). The drive plate 23 drives the locking assembly 4 (in the first locked state) to rotate together in the first direction (counterclockwise direction) around the drive shaft 22 (see FIG. 7A and FIG. 8A).

During the rotation of the drive plate 23 in the first direction (counterclockwise direction), the drive plate protrusion 238 of the drive plate 23 can push the unlocking lever reset protrusion 524 of the unlocking lever 52 (see FIG. 8A) to rotate the unlocking lever 52 around the unlocking lever fixed shaft 54 in the first direction (counterclockwise direction), thereby causing the unlocking lever push rod 522 of the unlocking lever 52 to push the electromagnetic drive element 51 of the unlocking assembly 5, thereby resetting the electromagnetic drive element 51 of the unlocking assembly 5 (see FIGS. 7A, 8A, and 9A).

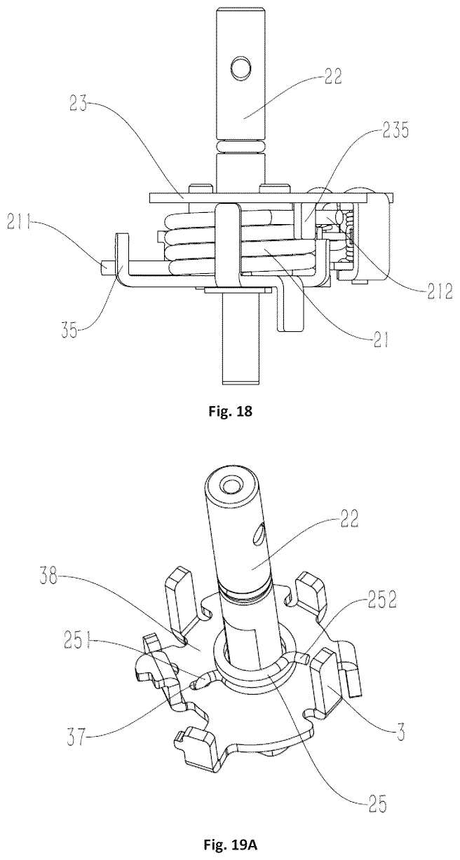

During the rotation of the drive plate 23 in the first direction (counterclockwise direction), the driving board 235 of the drive plate 23 pushes the energy storage element second torsion arm 212 of the energy storage element 21 to twist (see FIG. 18), allowing the energy storage element 21 to store energy. The energy storage element first torsion arm 211 of the energy storage element 21 applies a torsional moment in the first direction (counterclockwise direction) to the energy storage element stop plate 35 of the actuator 3. However, at this time, the energy storage element stop plate 35 of the actuator 3 is restricted by the buffer 13. Therefore, the deflection torsion spring first torsion arm 251 of the deflection torsion spring 25 and the actuator 3 are both in a stationary state relative to the base 11 of the housing 1.

Continue to rotate the handle 16 in the first direction (counterclockwise direction), the drive plate 23 and the locking assembly 4 continue to rotate around the drive shaft 22 in the first direction (counterclockwise direction), and the drive plate 23 drives the stop plate 413 of the locking rod 41 in the locking assembly 4 to come into contact with the push plate 32 provided on the actuator 3 (see FIG. 10).

Due to the stationary state of the actuator 3 relative to the housing 1 at this time, as the locking assembly 4 continues to rotate around the drive shaft 22 in the first direction (counterclockwise direction), the push plate 32 of the actuator 3 will come into contact with the stop plate 413 of the locking rod 3 and push the stop plate 413 to move, thereby causing the locking rod 41 in the locking assembly 4 to rotate around the locking rod fixed shaft 45 in the first direction (counterclockwise direction).

During the rotation of the locking rod 41 around the locking rod fixed shaft 45 in the first direction (counterclockwise direction), the locking rod connecting plate 418 of the locking rod 41 pushes the locking rod torsion spring first torsion arm 421 of the locking rod torsion spring 42 to twist, causing the locking rod torsion spring 42 to store energy. Meanwhile, the locking rod abutment surface 414 of the locking rod 41 no longer bears against the tripping rod abutment surface 433 of the tripping rod lower plate 436 of the tripping rod 43 (see FIG. 10), that is, the first locked state is released.

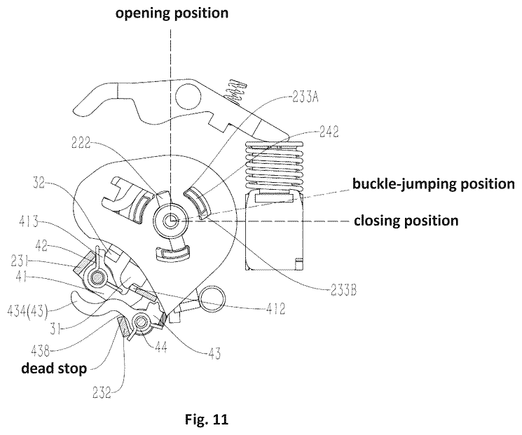

As shown in FIG. 10 and FIG. 11, after the locking rod abutment surface 414 of the locking rod 41 disengages from the tripping rod abutment surface 433 of the tripping rod 43, the locking rod 41 no longer restricts the tripping rod 43 from rotating in the first direction (counterclockwise direction).

Under the action of the torsional moment provided by the tripping rod torsion spring 44, the tripping rod 43 rotates around the tripping rod fixed shaft 46 in the first direction (counterclockwise direction) until the stopping surface 438 of the tripping arm 434 of the tripping rod 43 contacts the tripping rod fixing bent plate 232 of the operating assembly 2 and stops rotating (see FIG. 11).

During the rotation of the locking rod 41 around the locking rod fixed shaft 45 in the first direction (counterclockwise direction), the tripping rod 43 rotates in the first direction (counterclockwise direction) until the locking rod stop surface 415 of the locking rod 41 is close to the tripping rod stop surface 432 of the tripping rod 43. At this time, the locking protrusion 31 of the actuator 3 passes over and enters the locking groove 412 of the locking rod 41, but the locking protrusion 31 does not contact the locking groove 412 (see FIG. 11).

When the stop plate 413 of the locking rod 41 comes into contact with the locking rod fixing bent plate 231 of the drive plate 23, the locking rod 41 no longer rotates in the first direction (counterclockwise direction) around the locking rod fixed shaft 45 (see FIG. 11). At this time, the handle 16 is twisted in the first direction (counterclockwise direction) to an ultimate twisting position during the re-buckling energy storage process. In FIG. 11, the position where the stop plate 413 of the locking rod 41 contacts the locking rod fixing bent plate 231 of the drive plate 23 is exactly blocked out by the locking rod torsion spring 42.

The handle 16 is released to release the drive force of drive shaft 22, thereby releasing the driving force of the drive plate 23.

Under the action of the torsional moment provided by the energy storage element 21, the energy storage element first torsional arm 211 of the energy storage element 21 can apply a torsional moment to the driving board 235 of the drive plate 23 in the second direction (clockwise direction), causing the drive plate 23 to rotate in the second direction (clockwise direction), thereby driving the locking rod 41 to rotate around the drive shaft 22 in the second direction (clockwise direction). When the locking protrusion 31 comes into contact with the locking groove 412 of the locking rod 41, and meanwhile when the tripping rod stop surface 432 forms a bearing state with the locking rod stop surface 415 of the locking rod 41 (see FIG. 12), that is, when it is in the second locked state, the drive plate 23 stops rotating.

During the rotation of the locking rod 41 around the drive shaft 22 in the second direction (clockwise direction), the push plate 32 of the actuator 3 moves away from the stop plate 413 provided on the locking rod 3, releasing the bearing between the push plate 32 and the stop plate 413. Under the combined effect of the torsional moment applied by the locking rod torsion spring 42 and the locking protrusion 31 of the actuator 3, the locking rod 41 rotates around the locking rod fixed shaft 45 in the second direction (clockwise direction) until the locking groove 412 of the locking rod 41 is locked with the locking protrusion 31 of the actuator 3 (see FIG. 11 and FIG. 12). At this time, the operating assembly 2 completes the locking with the actuator 3 through the locking assembly 4 to form an interlocking structure, that is, the second locked state.

During the re-buckling energy storage process, the actuator 3 is restricted by the buffer 13 to be in a relatively stationary state relative to the housing 1, and the actuator 3 does not perform a switching action.

After releasing the handle 16, its deflection torsion spring 25 is in the forward torsion state, and under the torsional moment provided by the deflection torsion spring 25, the sleeve 24 rotates in the second direction (clockwise direction), thereby driving the handle 16 to rotate back to an opening indication position in the second direction (clockwise direction).

The specific changes of the deflection torsion spring 25 during the re-buckling energy storage process are as follows:

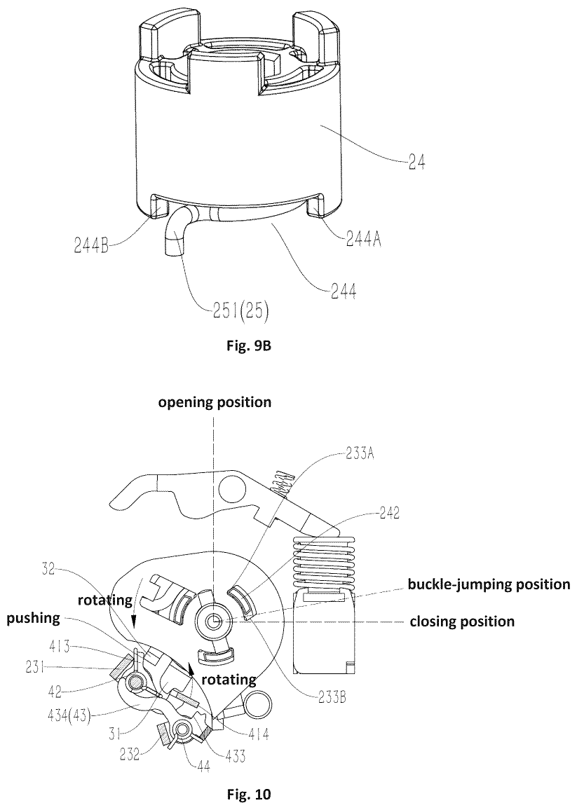

In the re-buckling energy storage process, the deflection torsion spring first torsion arm 251 of the deflection torsion spring 25 connected to the actuator 3 is a fixed torsion arm. When the handle 16 is rotated by a first preset angle in the first direction (counterclockwise direction), the energy storage torque of the deflection torsion spring 25 is released (in a certain state in FIG. 8B to FIG. 9B, due to the over-twisting by a second preset angle involved in the re-buckling energy storage process, the energy release of the deflection torsion spring should be completed at a position in the middle of the clearance groove 244 towards the first limiting surface 233A by about the second preset angle).

In the illustrated embodiment, the first preset angle is 40°, but its value can be adjusted as required, for example, it can be set to any value between 30° and 50°.

In the illustrated embodiment, the second preset angle is 8°, but its value can be adjusted as required, for example, it can be set to any value between 3° and 15°.

The handle 16 continues to be rotated in the first direction (counterclockwise direction), the deflection torsion spring 25 is rotated in forward torsion (the direction of contraction in the torsion spring), which drives the deflection torsion spring second torsion arm 252 to twist counterclockwise, so that the deflection torsion spring 25 stores energy again (forward torsion energy storage). At this time, the deflection torsion spring second torsion arm 252 of the deflection torsion spring 25 applies a torsional moment rotating in the second direction (clockwise direction) to the sleeve 24, and the deflection torsion spring first torsion arm 251 of the deflection torsion spring 25 applies a torsional moment in the first direction (counterclockwise direction) to the actuator 3.

After the re-buckling energy storage, the second locked state is completed.

The handle 16 is released, and under the action of the deflection torsion spring 25, the sleeve 24 is driven to rotate in the second direction (clockwise direction) until the sleeve drive protrusion 242 of the sleeve 24 contacts the second limiting surface 233B of the limiting slide slot 233 and stops (see FIG. 12). At this time, the handle 16 is deflected from the over-twisting angle to the opening position, and the pin 222 corresponding to the handle 16 is also deflected from the over-twisting angle to the opening position (see FIGS. 11 and 12).

### Manual Closing Process:

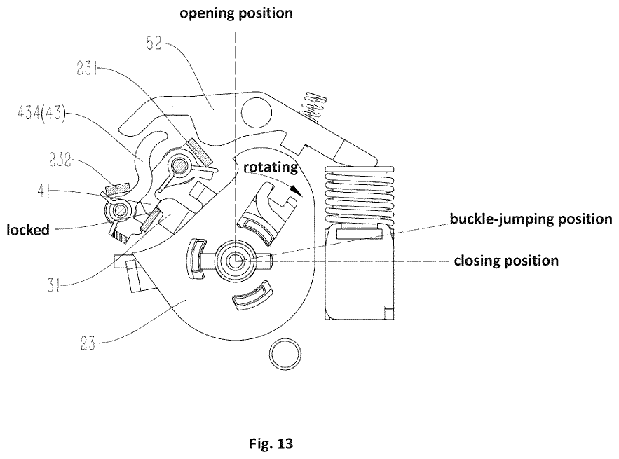

As shown in FIG. 13, after the above re-buckling energy storage is completed, the handle 16 is rotated in the second direction (clockwise direction), which drives the operating assembly 2 to rotate in the second direction (clockwise direction), and can drive the actuator 3 locked therewith to rotate in the second direction (clockwise direction), and the connection positioning plate 36 of the actuator 3 may perform the closing operation of the state-switching unit of the electrical control system. At this time, the locking rod fixing bent plate 231 of the drive plate 23 is restricted by the first stop 14 of the base 11, and the driving board 235 of the drive plate 23 is restricted by the second stop 15 of the base 11, preventing the drive plate 23 from further rotating in the second direction (clockwise direction).

### Manual Opening Process:

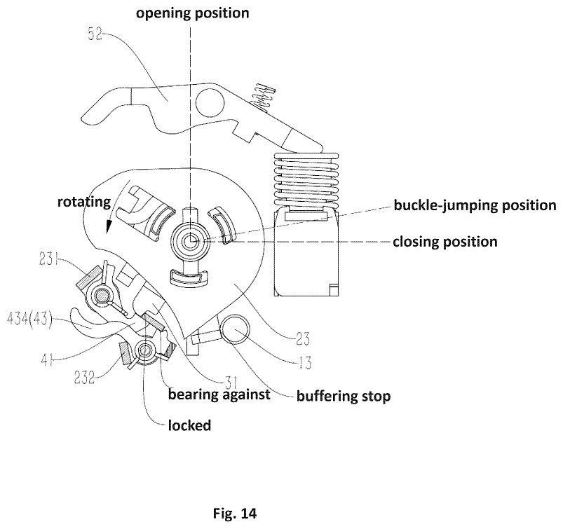

As shown in FIG. 14, after the above closing is completed, the handle 16 is rotated in the first direction (counterclockwise direction), which drives the operating assembly 2 to rotate in the first direction (counterclockwise direction), and may also drive the actuator 3 locked therewith to rotate in the first direction (counterclockwise direction), and the connection positioning plate 36 of the actuator 3 may perform the opening action of the state-switching unit of the electrical control system.

During the manual closing and manual opening processes, the locking assembly 4 is in the second locked state internally, and the energy storage element 21 is in the energy storage state.

The energy storage torque of the energy storage element 21 is greater than the energy storage torsional moment of the internal energy storage element in the operating mechanism of the state-switching unit of the electrical control system.

### Free Tripping Process:

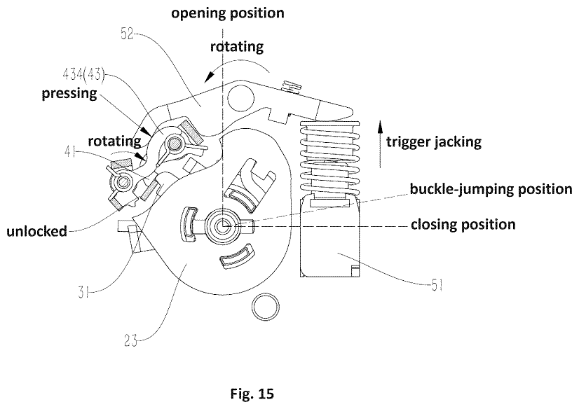

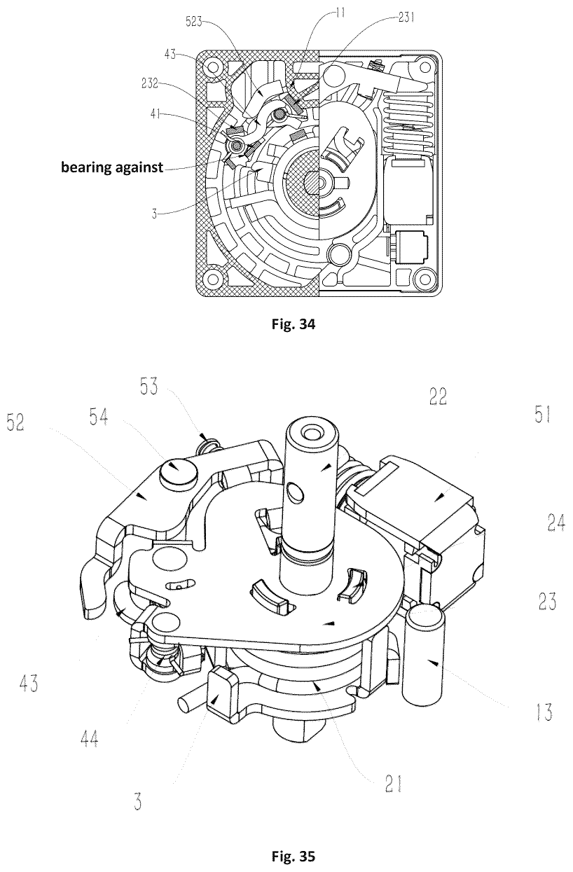

As shown in FIG. 15 and FIG. 34, after the above closing action is completed, in some special cases, the electromagnetic drive element 51 of the unlocking assembly 5 is triggered upon receiving the unlocking signal to push the unlocking lever push rod 522, causing the unlocking lever 52 to rotate around the unlocking lever fixed shaft 54 in the first direction (counterclockwise direction), thereby causing the unlocking lever press rod 523 of the unlocking lever 52 to push the tripping arm 434 of the tripping rod 43 to move, and thus causing the tripping rod 43 to rotate around the tripping rod fixed shaft 46 in the second direction (clockwise direction).

During the rotation of the tripping rod 43 around the tripping rod fixed shaft 46 in the second direction (clockwise direction), the tripping rod connecting plate 437 of the tripping rod 43 pushes the tripping rod torsion spring second torsion arm 442 of the tripping rod torsion spring 44 to twist, causing the tripping rod torsion spring 44 to store energy. At the same time, the tripping rod 43 rotates in the second direction (clockwise direction) around the tripping rod fixed shaft 46 until the locking rod stop surface 415 of the locking rod 41 and the tripping rod stop surface 432 of the tripping rod 43 no longer bears against each other, that is, the second locked state is released (see FIG. 15).

After the locking rod stop surface 415 of the locking rod 41 no longer bears against the tripping rod stop surface 432 of the tripping rod 43, the tripping rod 43 releases its bearing against the locking rod 41 and no longer restricts the locking rod 41 from rotating in the second direction (clockwise direction).

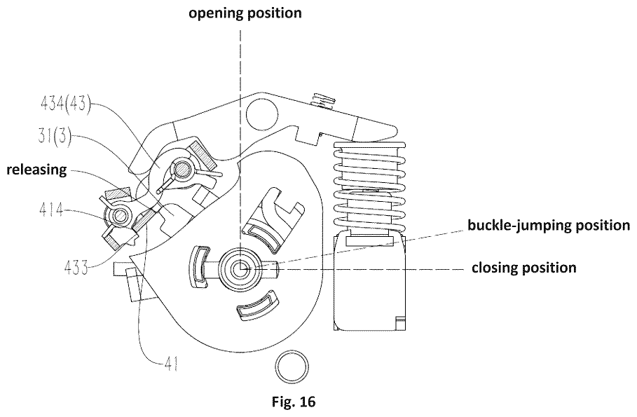

Under the action of the torsional moment provided by the locking rod torsion spring 421, the locking rod 41 rotates around the locking rod fixed shaft 45 in the second direction (clockwise direction) until the locking rod stop surface 415 on the locking rod 41 comes into contact with the tripping rod fixing bent plate 232 and stops rotating, or comes into contact with the tripping arm 434 of the tripping rod 43. At the same time, the locking rod abutment surface 414 of the locking rod 41 approaches or bears against the tripping rod abutment surface 433 of the tripping rod 43 (see FIG. 16). After resetting the unlocking lever 52, the locking rod abutment surface 414 of the locking rod 41 and the tripping rod abutment surface 433 of the tripping rod 43 are in a fully bearing state; If the unlocking lever 52 continuously applies force to the tripping rod 43, the locking rod abutment surface 414 of the locking rod 41 and the tripping rod abutment surface 433 of the tripping rod 43 may be either in a close state or in a bearing state.

During the rotation of the locking rod 41 around the locking rod fixed shaft 45 in the second direction (clockwise direction), the locking groove 412 of the locking rod 41 disengages from the locking protrusion 31 provided on the actuator 3, so that the locking rod 41 no longer restricts the rotation of the actuator 3 in the first direction (counterclockwise direction), that is, the locking rod 41 and the tripping rod 43 provided on the locking assembly 4 are in the first locked state.

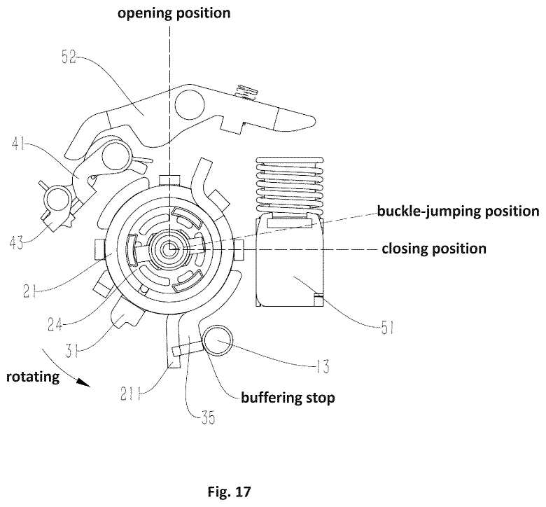

The energy storage element first torsion arm 211 of the energy storage element 21 applies a torsional moment to the energy storage element stop plate 35 of the actuator 3 (which is much greater than the torsional moment of the deflection torsion spring 25 and greater than the energy storage torsional moment of the internal energy storage element in the operating mechanism of the state-switching unit of the electrical control system), causing the actuator 3 to rotate in the first direction (counterclockwise direction) around the drive shaft 22 (see FIG. 17), and thus can perform the automatic opening action of the state-switching unit of the electrical control system to achieve a free tripping process (i.e., automatic opening process).

When the actuator 3 rotates in the first direction (counterclockwise) to the opening position, it collides with the buffer 13 provided on the base 11 and stops (see FIG. 17).

During the energy release process of the energy storage element 21, a torsional moment is applied to the drive plate 23, which causes the drive plate 23 to have a tendency to rotate in the second direction (clockwise direction). The locking rod fixing bent plate 231 of the drive plate 23 is restricted by the first stop 14 of the base 11, and the driving board 235 of the drive plate 23 is restricted by the second stop 15 of the base 11. The drive plate 23 cannot rotate in the first direction (counterclockwise direction), and the drive plate 23 is stationary relative to the base 11.

After free tripping, the energy storage element 21 applies a torsional moment in the second direction (clockwise direction) to the drive plate 23 of the operating assembly 2, and the first stop 14 and the second stop 15 of the base 11 of the housing 1 can restrict the clockwise rotation of the drive plate 23 of the operating assembly 2.

### Handle Deflection Indication:

After the free tripping process, it is necessary to rotate the handle 16 back to the buckle-jumping position, that is, to automatically achieve the handle deflection indication.

When the switch is in the closed state, the handle 16 points to the closing position.

When performing free tripping, that is, when the handle 16 or the rotary shaft is stuck, it can achieve free tripping and complete automatic opening; When the stuck handle 16 or the stuck shaft 221 connected to the handle 16 is released, the handle 16 cannot point to the closing position and needs to be driven to deflect a certain angle from the closing position to the opening position.

At this time, the deflection torsion spring 25 can drive the sleeve 24 to drive the drive shaft 22 and the handle 16 to rotate in the first direction (counterclockwise direction), pointing to the buckle-jumping position.

Before the free tripping, the deflection torsion spring is in an energy storage state (the energy storage at this time is the energy stored after the re-buckling process is completed).

In the first stage of the free tripping process, the deflection torsion spring first torsion arm 251 applies a torsional moment to the actuator 3 in the first direction (counterclockwise direction), that is, the actuator 3 is driven to rotate in the first direction (counterclockwise direction), and when the energy stored in the deflection torsion spring 25 is released, the first stage of the free tripping process ends.

In the second stage of the free tripping process, under the action of the torsional moment provided by the energy storage element 21, the actuator 3 drives the deflection torsion spring first torsion arm 251 to rotate in the first direction (counterclockwise direction), causing the deflection torsion spring 25 to store energy again (reverse torsion energy storage). Due to the energy storage of the deflection torsion spring 25, the deflection torsion spring second torsion arm 252 of the deflection torsion spring 25 is connected to the sleeve 24, and applies a torsional moment in the first direction (counterclockwise direction) to the sleeve 24, driving the sleeve 24 to rotate in the first direction (counterclockwise direction) within the movable range of the limiting slide slot 233 of the drive plate 23 (i.e., from the position in contact with the second limiting surface 233B to the position in contact with the first limiting surface 233A), and then drives the handle 16 to point to the buckle-jumping position.

At the same time, the deflection torsion spring first torsion arm 251 of the deflection torsion spring 25 for re-buckling energy storage drives the actuator 3 to rotate by a certain angle in the first direction (counterclockwise direction) until the energy storage of the deflection torsion spring 25 is released. Then, the energy storage element 21 continues to drive the actuator 3 to rotate in the first direction (counterclockwise direction), so that the actuator 3 continues to rotate in the first direction (counterclockwise direction) and in turn drives the deflection torsion spring first torsion arm 251 to rotate, driving the deflection torsion spring 25 to twist again for energy storage (reverse torsion energy storage), thereby causing the deflection torsion spring second torsion arm 252 of the deflection torsion spring 25 to apply a torsional moment in the first direction (counterclockwise direction) to the sleeve 24.

Before the start of the re-buckling energy storage process, the state of the deflection torsion spring 25 is the reverse torsion energy storage (energy stored during the free tripping process), and during the re-buckling energy storage process, the state of the deflection torsion spring 25 passes from the reverse torsion energy storage to energy release, and then to the forward torsion energy storage.

Before the start of the free tripping process, the state of the deflection torsion spring 25 is the forward torsion energy storage (energy stored during the re-buckling process), and during the free tripping process, the state of the deflection torsion spring 25 passes from the forward torsion energy storage to energy release, and then to the reverse torsion energy storage.

The re-buckling energy storage process and the free tripping process form a cyclic process.

Before the re-buckling energy storage, the deflection torsion spring may be in the forward torsion energy storage; before free tripping, the deflection torsion spring may be in the reverse torsion energy storage. That is, the deflection torsion spring is in a cyclic process; changing the winding direction of the deflection torsion spring can achieve an opposite torque set by the deflection torsion spring in the embodiment, which can achieve the same effect. The embodiment is intended to take one of the approaches; the closing state of the state-switching unit of the electrical control system is the normal use state of the state-switching unit of the electrical control system; in the closing state of the state-switching unit of the electrical control system, the state of the deflection torsion spring is forward torsion energy storage state.

The energy storage mechanism for state switching operation of the electrical control system in the embodiments of the present invention can achieve independent tripping energy storage, that is, the tripping energy storage process and the energy storage process of the internal energy storage element in the operating mechanism of the state-switching unit of the electrical control system are independent from each other. Before operating the operating mechanism of the state-switching unit of the electrical control system, the re-buckling energy storage of the tripping device needs to be performed first. After the re-buckling energy storage, normal operation of the operating mechanism of the state-switching unit of the electrical control system can be carried out, that is, before operating the operating mechanism of the state-switching unit of the electrical control system, the tripping device must perform re-buckling energy storage for the tripping device first. Before the re-buckling energy storage, it is impossible to perform closing and opening operations, which makes it easier, safer, and more reliable to operate the operating mechanism of the state-switching unit of the electrical control system. The energy storage mechanism for operating the state-switching unit of the electrical control system in the embodiments of the present invention also has a free tripping function. Even when the handle 16 or the rotary shaft of the handle is stuck at the moment of closing the operation switch, the tripping function can still be achieved, improving the safety performance of the state-switching unit of the electrical control system. And it has a simple structure and stable function, and the energy storage element has a high utilization rate for energy release. In addition, the closing process of the energy storage mechanism is not operated at the same time as the closing process of the operating mechanism of the state-switching unit of the electrical control system, which prevents the torsional moment of the energy storage process from overlapping with the torsional moment in the closing process of the operating mechanism of the state-switching unit of the electrical control system, thus avoiding the generation of large operating torque.

For convenience of interpretation and precise limitation of the appended claims, the terms “up”, “down”, “in”, “out”, “on”, “below”, “upper”, “lower”, “upward”, “downward”, “front”, “rear”, “back”, “inside”, “outside”, “inward”, “outward”, “internal”, “external”, “interior”, “exterior”, “forwards”, “backwards” are used to describe the features of the exemplary embodiments with reference to the positions of these features shown in the accompanying drawings.

The aforementioned description of the specific exemplary embodiments of the present invention is for the purpose of illustration and description. The preceding description is not intended to be exhaustive, nor is it intended to limit the invention to the precise form disclosed. Obviously, many changes and variations are possible based on the above teachings. The purpose of selecting and describing exemplary embodiments is to explain the specific principles and practical applications of the present invention, so that other technicians in the art can implement and utilize various exemplary embodiments of the present invention, as well as various alternatives and modifications. The scope of the present invention is intended to be limited by the appended claims and their equivalents.

1. An energy storage mechanism for state switching operation in an electrical control system, characterized in comprising:
a housing;
an operating assembly mounted to the housing and including an energy storage element;
an actuator connected to a state-switching unit of the electrical control system;
a locking assembly mounted to the operating assembly or the actuator, wherein the energy storage element connects the operating assembly and the actuator and is enabled to store energy by changing a relative position between the operating assembly and the actuator, and after the relative position between the operating assembly and the actuator is changed to a predetermined position, the operating assembly is connectable to the actuator through the locking assembly to be in a locked state; the operating assembly is then driven to move in an opposite direction, which drives the actuator to move in the same direction, and the operating assembly drives the actuator to reach a restricted position of the operating assembly restricted by the housing, thereby causing the actuator to drive the position state of the state-switching unit of the electrical control system to change; and
an unlocking assembly mounted to the housing or the operating assembly or the actuator, wherein the unlocking assembly, upon receiving a trigger signal, is capable of releasing the locked state between the operating assembly and the actuator, allowing the energy storage element to release the stored energy, and the operating assembly is restricted by the housing from moving in a direction in which a force is applied thereto by the energy storage element; the actuator is movable in a direction in which a force is applied thereto by the energy storage element under driving of energy release of the energy storage element, thereby driving the position state of the state-switching unit of the electrical control system to change again.

2. The energy storage mechanism for state switching operation in an electrical control system according to claim 1, characterized in that the operating assembly is rotated in a first direction to change the relative position between the operating assembly and the actuator so that the energy storage element stores energy; after the operating assembly rotates to a predetermined position relative to the actuator, the operating assembly is connectable with the actuator via the locking assembly to be in a locked state; the operating assembly is then rotated in a second direction, which drives the actuator to rotate in the second direction, and the operating assembly drives the actuator to reach a restricted position of the operating assembly restricted by the housing, thereby causing the actuator to drive the position state of the state-switching unit of the electrical control system to change.

3. The energy storage mechanism for state switching operation in an electrical control system according to claim 1, characterized in that the operating assembly and the actuator are locked by the locking assembly, so as to be combined as a whole and can move together, and the energy storage element connected between the operating assembly and the actuator stores energy, which can force the relative position between the operating assembly and the actuator to have a tendency to move away, or can force the relative position between the operating assembly and the actuator to have a tendency to move closer.

4. The energy storage mechanism for state switching operation in an electrical control system according to claim 1, characterized in that the locking assembly comprises a locking part and a tripping part, wherein by changing position state of the locking part, connection between the operating assembly and the actuator is achieved to be a locked state, thereby enabling the operating assembly to move in the same direction as the actuator and driving the position state of the state-switching unit of the electrical control system to change; or
wherein by changing position state of the tripping part via the unlocking assembly, the locked state between the operating assembly and the actuator is released, thereby enabling the energy storage element to release energy and drive the actuator to move.

5. (canceled)

6. The energy storage mechanism for state switching operation in an electrical control system according to claim 2, characterized in that the locking assembly comprises a locking part and a tripping part, wherein the locking part comprises a locking rod and a locking rod torsion spring that applies a torsional moment to the locking rod and is capable of causing the locking rod to rotate in the second direction or have a tendency to rotate in the second direction; the locking rod is mounted to the operating assembly through a locking rod fixed shaft and is rotatable around the locking rod fixed shaft, and
wherein the tripping part comprises a tripping rod and a tripping rod torsion spring that applies a torsional moment to the tripping rod and is capable of causing the tripping rod to rotate in the first direction or have a tendency to rotate in the first direction; the tripping rod is mounted to the operating assembly through a tripping rod fixed shaft and is rotatable around the tripping rod fixed shaft.

7. The energy storage mechanism for state switching operation in an electrical control system according to claim 6, characterized in that the locking rod comprises:
a locking rod upper plate that is horizontally arranged;
a locking rod lower plate that is horizontally arranged and has a stop plate, wherein the locking rod upper plate and the locking rod lower plate each have a locking rod limit hole for the locking rod fixed shaft to pass through; and
a locking rod connecting plate that is vertically arranged, by which the locking rod upper plate is connected to the locking rod lower plate, wherein an end face of the locking rod connecting plate facing the locking rod limit hole has a locking groove, a side of the locking rod connecting plate away from the locking rod limit hole has a locking rod abutment surface, and the locking rod connecting plate further has a locking rod stop surface facing away from the stop plate, and
the tripping rod comprises:
a tripping rod upper plate that is horizontally arranged;
a tripping rod lower plate that is horizontally arranged, and has a tripping rod stop surface and a tripping rod abutment surface, wherein the tripping rod stop surface is used to cooperate with the locking rod stop surface on the locking rod to form a bearing state, so that the operating assembly forms an interlocking structure with the actuator through the locking part; and
a vertical tripping rod connecting plate, by which the tripping rod upper plate is connected to the tripping rod lower plate.

8. The energy storage mechanism for state switching operation in an electrical control system according to claim 7, characterized in that the tripping rod lower plate further includes a tripping arm.

9. The energy storage mechanism for state switching operation in an electrical control system according to claim 2, characterized in that the locking part comprises a locking rod which is mounted to the operating assembly through a locking rod fixed shaft, wherein the locking rod comprises:
a locking rod upper plate that is horizontally arranged;
a locking rod lower plate that is horizontally arranged and has a stop plate, wherein the locking rod upper plate and the locking rod lower plate each have a locking rod limit hole for the locking rod fixed shaft to pass through; and
a locking rod connecting plate that is vertically arranged, by which the locking rod upper plate is connected to the locking rod lower plate, wherein an end face of the locking rod connecting plate facing the locking rod limit hole has a locking groove, and
wherein the actuator includes a plate-shaped actuator body, which has sequentially at an outer edge thereof extending upward:
a push plate that is contactable with the stop plate of the locking rod and can force the locking rod to rotate around the locking rod fixed shaft in the first direction after contact;
a locking protrusion that can be locked in cooperating with the locking groove of the locking rod; and
a stop plate of the energy storage element.

10. The energy storage mechanism for state switching operation in an electrical control system according to claim 2, characterized in that the actuator comprises a plate-shaped actuator body, which has at an outer edge thereof a connection positioning plate that is extending downward and passes downward through the housing to be connected with the state-switching unit of the electrical control system, wherein when the actuator rotates in the second direction, the state-switching unit of the electrical control system performs closing operation, and when the actuator rotates in the first direction, the state-switching unit of the electrical control system performs opening operation.

11. The energy storage mechanism for state switching operation in an electrical control system according to claim 9, characterized in that the actuator body further has a deflection torsion spring limit hole.

12. The energy storage mechanism for state switching operation in an electrical control system according to claim 2, characterized in that the unlocking assembly comprises:
an unlocking lever, which is mounted to the housing through an unlocking lever fixed shaft and is rotatable around the unlocking lever fixed shaft;
an electromagnetic drive element that can drive the unlocking lever to rotate in the first direction upon receiving a trigger signal; and
an unlocking lever return spring for providing an elastic supporting force to the unlocking lever so that one end of the unlocking lever remains close to or in contact with the electromagnetic drive element.

13. The energy storage mechanism for state switching operation in an electrical control system according to claim 2, characterized in that the unlocking assembly comprises:
an unlocking lever which is mounted to the housing through the unlocking lever fixed shaft and is rotatable around the unlocking lever fixed shaft;
an electromagnetic drive element that can drive the unlocking lever to rotate in the first direction upon receiving a trigger signal; and
a unlocking lever return spring for providing an elastic supporting force to the unlocking lever so that one end of the unlocking lever remains close to or in contact with the electromagnetic drive element,
wherein the locking assembly comprises a locking part and a tripping part, wherein the tripping part comprises a tripping rod which is mounted to the operating assembly through a tripping rod fixed shaft and is rotatable around the tripping rod fixed shaft, and the tripping rod has a tripping arm;
the unlocking lever comprises an unlocking lever body;
a first end of the unlocking lever body has a first extension plate extending downward and an unlocking lever push rod extending from a lower end of the first extension plate in a direction away from the unlocking lever body, the unlocking lever push rod being close to or in contact with the electromagnetic drive element;
a second end of the unlocking lever body has a second extension plate extending downward and an unlocking lever press rod extending from a lower end of the second extension plate in a direction away from the unlocking lever body, the unlocking lever press rod being able to be close to or in contact with the tripping arm of the tripping rod, and being able to drive the tripping rod to rotate around the tripping rod fixed shaft in the second direction by pressing the tripping arm, thereby unlocking the locking assembly;
the unlocking lever body has an unlocking lever stop plate near the first end thereof, and one end of the unlocking lever return spring bears against the unlocking lever stop plate; and
the unlocking lever body has a unlocking lever reset protrusion near the second end thereof, wherein when the electromagnetic drive element is in the triggered state, the operating assembly cooperates with the unlocking lever reset protrusion during rotating in the first or second direction, and pushes the unlocking lever to move so as to drive the electromagnetic drive element to complete the reset.

14. The energy storage mechanism for state switching operation in an electrical control system according to claim 2, characterized in that the actuator comprises an energy storage element stop plate;
the operating assembly comprises said energy storage element, a drive shaft, a drive plate, a sleeve, a deflection torsion spring, and a handle,
wherein the sleeve is provided on the actuator;
the drive plate is mounted at the top of the sleeve, which can rotate by a predetermined angle relative to the drive plate around an axis of the sleeve;
the drive shaft is mounted in the sleeve and fits with the sleeve in a way that allows them to rotate in the same direction, with the top of the drive shaft passing through the top of the housing, and the bottom thereof passing through the bottom of the housing;
the handle is mounted to the top of the drive shaft;
the deflection torsion spring is provided at the bottom of the sleeve, and connects the sleeve and the actuator and can apply a torsional moment to the sleeve, so that the sleeve can rotate in a direction in which a torsional moment is applied thereto by the deflection torsion spring;
the energy storage element is sleeved on the sleeve and has an energy storage element first torsion arm and an energy storage element second torsion arm, wherein the energy storage element first torsion arm bears against the energy storage element stop plate of the actuator to apply a torsional moment in the first direction to the actuator, causing the actuator to rotate around the drive shaft in the direction in which a torsional moment is applied thereto by the energy storage element.

15. The energy storage mechanism for state switching operation in an electrical control system according to claim 1, characterized in that the operating assembly comprises a drive plate;
the locking assembly comprises a locking part including a locking rod and a tripping part including a tripping rod;
the drive plate comprises a plate-shaped drive plate body, which has at an outer edge thereof a locking rod fixing bent plate and a tripping rod fixing bent plate extending downward,
wherein the locking rod is mounted to the locking rod fixing bent plate through a locking rod fixed shaft, and the tripping rod is mounted to the tripping rod fixing bent plate through a tripping rod fixed shaft.

16. The energy storage mechanism for state switching operation in an electrical control system according to claim 2, characterized in that the operating assembly comprises a drive shaft, a drive plate, and said energy storage element which has an energy storage element first torsion arm and an energy storage element second torsion arm, wherein the drive plate comprises a plate-shaped drive plate body having:
a driving board extending downward, wherein the energy storage element second torsion arm of the energy storage element bears against the driving board to apply a torsional moment in the second direction to the operating assembly, such that the operating assembly has a tendency to rotate or rotate around an axis of the drive shaft in the direction in which a torsional moment is applied thereto by the energy storage element.

17. The energy storage mechanism for state switching operation in an electrical control system according to claim 15, characterized in that,
the locking assembly comprises a locking part including a locking rod that includes a locking rod upper plate and a locking rod lower plate;
the drive plate body further has a clearance slide slot;
the locking rod torsion spring has a locking rod torsion spring first torsion arm and two locking rod torsion spring second torsion arms;
the locking rod torsion spring first torsion arm bears against the locking rod fixing bent plate;
one of the two locking rod torsion spring second torsion arms bears against the locking rod upper plate and is inserted into the clearance slide slot of the drive plate body, and can provide a torsional moment to the locking rod upper plate; the other of the two locking rod torsion spring second torsion arms bears against the locking rod lower plate, and can provide a torsional moment to the locking rod lower plate;
during rotation of the locking rod around the locking rod fixed shaft, one of the two locking rod torsion spring second torsion arms of the locking rod torsion spring is slidable along the clearance slide slot of the drive plate body to prevent the drive plate from obstructing the torsion of the one of the two locking rod torsion spring second torsion arms.

18. The energy storage mechanism for state switching operation in an electrical control system according to claim 14, characterized in that the drive plate comprises a plate-shaped drive plate body which has:
at least one limiting slide slot having a predetermined length in a circumferential direction, having a first limiting surface at a first end in the circumferential direction and a second limiting surface at a second end in the circumferential direction, and extending from the first limiting surface to the second limiting surface in the second direction,
wherein the sleeve has a sleeve central hole passing through in the vertical direction, and has at its top a sleeve drive protrusion corresponding to the limiting slide slot, each sleeve drive protrusion being inserted into a corresponding limiting slide slot, and the sleeve drive protrusion being slidable along the limiting slide slot, so that the sleeve can rotate by a predetermined angle relative to the drive plate around the drive shaft.

19. The energy storage mechanism for state switching operation in an electrical control system according to claim 18, characterized in that the bottom of the sleeve has:
a concave hole for accommodating the deflection torsion spring;
a clearance groove having a predetermined length in a circumferential direction, having a first clearance end face at a first end in the circumferential direction and a second clearance end face at a second end in the circumferential direction, and extending from the first clearance end face to the second clearance end face in the second direction; and
a limiting groove.

20. The energy storage mechanism for state switching operation in an electrical control system according to claim 19, characterized in that the deflection torsion spring comprises:
a deflection torsion spring first torsion arm that is inserted into a deflection torsion spring limit hole of the actuator body of the actuator after passing through the clearance groove of the sleeve; and
a deflection torsion spring second torsion arm that is inserted into the limiting groove of the sleeve and can apply a torsional moment to the sleeve,
wherein the deflection torsion spring second torsion arm of the deflection torsion spring is able to apply a torsional moment in the first direction to the sleeve so as to push the handle to deflect from a closing position to a buckle-jumping position;
the deflection torsion spring second torsion arm of the deflection torsion spring is able to apply a torsional moment in the second direction to the sleeve so as to push the handle to deflect from an over-twisting angle to an opening position.

21. The energy storage mechanism for state switching operation in an electrical control system according to claim 1, characterized in that the housing is further provided with:
a first stop that can cooperate with the locking rod fixing bent plate of the drive plate to limit rotation of the drive plate in the direction in which a torsional moment is applied thereto by the energy storage element;
a second stop that can cooperate with the driving board of the drive plate to limit rotation of the drive plate in the direction in which a torsional moment is applied thereto by the energy storage element; and
a buffer, which is provided on the housing and is used to buffer and restrict the actuator from rotating to a set position when the actuator rotates in the direction in which a torsional moment is applied thereto by the energy storage element under driving of energy release from the energy storage element.

22-23. (canceled)
